(19) United States
(12) Patent Application Publication
(10) Pub. No.: US 2004/0003046 A1
(43) Pub. Date: Jan. 1, 2004

(54) System and methods for providing instant services in an internet protocol network

(75) Inventors: David Grabelsky, Skokie, IL (US); Anoop Tripathi, Mt. Prospect, IL (US); Michael Homeier, Elmhurst, IL (US); Michael S. Borella, Naperville, IL (US)

Correspondence Address: McDonnell Boehnen Hulbert & Berghoff, 32nd Floor, 300 S. Wacker Drive, Chicago, IL, 60606, US

(73) Assignee: 3Com Corporation, Santa Clara, CA (US)

(21) Appl. No.: 10/021,171

(22) Filed: Dec. 12, 2001

(51) Int. Cl. G06F 15/16

(52) U.S. Cl. 709/206; 709/227

(57) ABSTRACT

A system and methods are shown for providing instant services in an Internet Protocol network. One of the methods comprises the steps of provisioning a first communication session between a first user terminal and a predetermined network device and provisioning a second communication session between a second user terminal and the predetermined network device. The exemplary method further includes receiving an activation request to establish an active communication session between the first user terminal and the second user terminal and, responsively, bridging the first communication session to the second communication session on the predetermined network device.

### FIELD OF THE INVENTION

The present invention relates to communications in mobile Internet Protocol (“IP”) networks. In one aspect of a preferred embodiment, it relates to providing instant voice messaging in such networks.

### BACKGROUND OF THE INVENTION

With the rapidly growing interest in wireless communications and Internet connectivity, wireless service providers are competing to capture the market share by offering their customers access to applications that take advantage of both technologies. However, as service providers attempt to widen their customer base, they are discovering inherent difficulties of providing combined voice and data services within circuit-switched networks. These infrastructures cannot meet the enormous demand for bandwidth or support timely, cost-effective delivery of emerging services and applications.

In a mobile Internet Protocol network, a mobile communication device (a mobile node), such as a mobile host or router that changes its point of attachment from one network to another, communicates with a target host on an Internet Protocol (“IP”) network by means of two devices, a “foreign agent” and a “home agent.” Typically, the foreign agent's functionality is incorporated into a router on a mobile node's visited network. The foreign agent provides routing services for the mobile node while it is registered with the home agent. For example, the foreign agent de-tunnels and delivers data packets that were tunneled by the mobile node's home agent to the mobile node.

A home agent is typically incorporated into a router on a mobile node's home network. The home agent maintains current location information for the mobile node. When one or more home agents are handling calls for multiple mobile nodes simultaneously, the home agents are providing, in essence, a service analogous to a virtual private network service.

Mobile Internet Protocol requires the link layer connectivity between a mobile node (a mobile entity) and a foreign agent. However, in some systems the link layer from the mobile node may terminate at a point distant from the foreign agent. Such networks are commonly referred to as third-generation (3G) wireless networks. A 3G network delivers much greater network capacity than many currently existing circuit-switched digital mobile networks. The increased availability of bandwidth in 3G networks opens up a new generation of applications to wireless subscribers such as collaborative and multimedia services.

One of the goals of the architecture of next generation IP networks is a framework for the to introduction of new multimedia services and features at the Internet speed, using IP-based applications and protocols. This has led to a differentiation of the functional and operational aspects of multimedia networks within three layers or planes, defined broadly as media processing, control and service creation. The service creation plane is sometimes further subdivided into an application plane and a data plane. The initial next generation IP networks have been aimed at building the infrastructure that realizes the architectural framework. At the same time, the list of IP-based multimedia services ready for deployment has grown steadily ahead of what may eventually be a great multiplicity of new services and features. Thus, the successful introduction of the next-generation services depends not only on how useful the services are to end users, but also on how intelligently they integrate capabilities of the underlying network system.

Therefore, a need exist for methods and systems for providing multimedia services.

### SUMMARY OF THE INVENTION

The system and method described herein is for providing instant services in an Internet Protocol network, the method comprising the steps of provisioning a first communication session between a first user terminal and a predetermined network device; provisioning a second communication session between a second user terminal and the predetermined network device; receiving an activation request to establish an active communication session between the first user terminal and the second user terminal; bridging the first communication session to the second communication session on the predetermined network device.

Further aspects of the preferred method include receiving on a presence server from a first user terminal a request to subscribe to a multimedia service; sending from the presence server to a conference server a request to provision a first communication session between the first user terminal and the conference server; provisioning the first communication session between the first user terminal and the conference server responsive to receiving the request; providing online status information associated with a user associated with the first user terminal to at least one user authorized to receive the online status information; provisioning a second communication session between the conference server and a second user terminal; providing online status information associated with a user associated with the second user terminal to the user associated with the first user terminal; receiving on the conference server an activation request to establish an active session between the first user terminal and the second user terminal; bridging the first communication session to the second communication session on the conference server.

These as well as other aspects and advantages of the present invention will become more apparent to those of ordinary skill in the art by reading the following detailed description, with reference to the accompanying drawings.

### BRIEF DESCRIPTION OF THE DRAWINGS

Exemplary embodiments of the present invention are described with reference to the following drawings, in which:

FIG. 1 is a functional block diagram illustrating an embodiment of a network architecture suitable for application in the present invention for providing instant voice messaging in an IP network according to an exemplary embodiment;

FIG. 2 is a block diagram illustrating different client devices that may be employed in a network architecture for providing instant voice messaging in an IP network according to an exemplary embodiment;

FIGS. 3A and 3B are a message flow illustrating a SIP user registration and a SIP user subscription to instant voice messaging according to an exemplary embodiment;

FIGS. 4A and 4B are a message flow illustrating a process for creating an active connection between users and sending an instant voice messages according to an exemplary embodiment;

FIGS. 5A and 5B are a message flow illustrating how a SIP user agent uses a voice messaging service to create an active connection to another online user in a network architecture using a plurality of conference servers according to an exemplary embodiment;

FIG. 6 is a message flow illustrating how a SIP user agent un-subscribes to and deregisters from the instant voice messaging service according to an exemplary embodiment;

FIG. 7 is a block diagram illustrating a network architecture for providing instant voice messaging service to client devices in a second generation network in which user terminals employ virtual user agents according to an exemplary embodiment;

FIG. 8 is a message flow illustrating registration/subscription and providing instant voice messaging services in the system architecture of FIG. 7;

FIG. 9 is a block diagram illustrating an exemplary network architecture for providing instant voice messaging services in a third generation network in which user terminals employ virtual user agents according to one exemplary embodiment;

FIG. 10 is a message flow illustrating registration/subscription and providing instant voice messaging services in the system architecture of FIG. 9;

FIG. 11 is a block diagram illustrating an exemplary network architecture for providing instant voice messaging services in a third generation network in which a user terminal has a SIP user agent; and

FIG. 12 is a message flow illustrating registration/subscription and providing instant voice messaging services in the system architecture of FIG. 11.

### THE DETAILED DESCRIPTION OF THE PREFERRED EMBODIMENT(S)

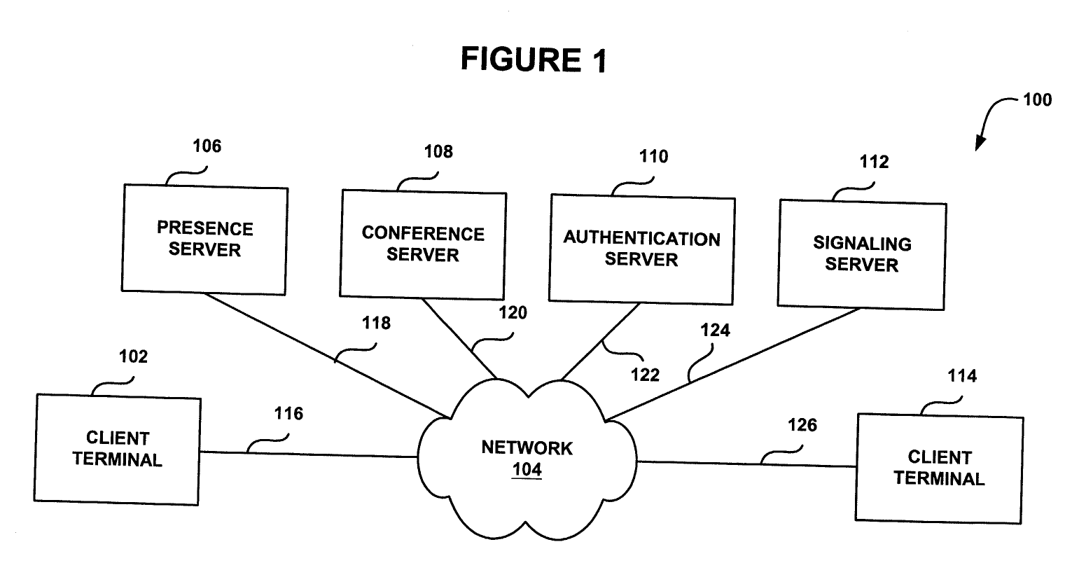

FIG. 1 is a functional block diagram illustrating an embodiment of a network architecture 100 suitable for application in the present invention for providing instant services, such as instant voice messaging, in an IP network. The network architecture includes a network 104 such as a world wide web or a public network that provides a communication path between a client terminal 102 and a client terminal 114. The client terminals 102 and 114 may take any suitable form such as, for example, a telephone, a computer, or a personal digital assistant (“PDA”). The client terminals 102 and 104 are connected to the network 104 via communication links 116 and 126, respectively. The communication links 116 and 126 may include a wireless communication link, a wireline communication link, or a combination thereof. According to an exemplary embodiment, a user of the client terminal 102 may send real-time voice messages to a predetermined group of users. For example, as will be described in greater detail below, a user of the client terminal 102 may initiate sending instant messaging by depressing a predetermined button (real or virtual) available on the client terminal 102. In an alternative embodiment, the user may initiate the service by dialing a predetermined set of digits. Further, alternatively, a user may initiate the service by selecting a predetermined icon, such as a graphical icon, available on the client terminal 102.

As further illustrated in FIG. 1, the network architecture 100 includes a presence server 106, a conference server 108, an authentication server 110, and a signaling server 112 interconnected to the network 104 via communication links 118, 120, 122, and 124, respectively. According to an exemplary embodiment, the presence server 106 controls and manages status and information associated with users who subscribed to multimedia services. In particular, the presence server 106 detects an activity status of a user and tracks a user's state with respect to protocols and subscribed services. As will be described in greater detail below, a user may register with the presence server 106 and subscribe to a specific service or services such as an instant voice messaging service, for example. When a user registers with the presence server 106, the presence server 106 identifies the user according to a preexisting account and the user may subscribe to a specific service or a number of services associated with that account. According to an exemplary embodiment, when a user registers with the presence server 106, the user may subscribe to an instant voice messaging service, for example. However, it should be understood that the services are not limited to instant voice messaging services, and different multimedia services requiring, for example, knowledge of user's presence and state could be provided as well.

According to an exemplary embodiment, a user subscription may be associated with a single predetermined service. Alternatively, a service may support multiple subscriptions from a single, registered user, and different subscriptions may be distinguished and tracked by the presence server 106 using different subscription identifiers. In such an embodiment, when a single user is associated with multiple subscriptions for a single service, the user may employ different user identities.

According to an exemplary embodiment, support for multiple services or multiple user identities associated with a service can be accomplished on the presence server 106 in a number of ways. For example, the presence server 106 may be configured to allow multiple, simultaneous subscriptions to a service under a single registration, assuming different identifiers for each subscription request. Alternatively, the presence server 106 could be provisioned to accept a single subscription per registration, and allow multiple, simultaneous registrations from a single user as means to provide multiple, simultaneous subscriptions. The first approach might offer service providers more concise accounting information, while the second approach might result in a simpler implementation of the presence server 106. Thus, either approach could be selected depending on the need or preferences of network developers. The embodiments of message flows illustrated in subsequent figures illustrate the registration and subscription as distinct steps, a likely characteristic of the first approach. However, it should be understood that message flows could be developed for the second approach as well.

Table 1 provides an example of the user information that might be maintained on the presence server 106, or on an external database associated with the presence server 106, for each user that registers and comes online to use instant multimedia services according to exemplary embodiments.

TABLE 1

| Item | State | Parameters |
|---|---|---|
| Subscrip- | {Registered, | {authorized receive-from correspondents}, |
| tion ID | Subscribed} | {authorized send-to correspondents} |
| Confer- | {OK, Error, . . . } | {IP address/RTP port connected to user, |
| ence | | IP address of |
| Server ID | | control interface, . . . } |
| Send/ | {Send, Receive} | {Send-to conference server IP address(es)/ |
| Receive | | RTP port(s), |
| | | Receive-from conference server IP |
| | | address/RTP port} |
| Avail- | {Is available, | {Reason code} |
| ability | Is Not available} | |
| Statistics | NA | {packets sent/received, time online, . . . } |
| Restric- | {restricted states} | {authorized states} |
| tions | | |

As illustrated in Table 1, a user profile record may include information regarding one or more subscription identifiers employed by a user, along with a list of authorized correspondents. In one embodiment, the user profile may specify two lists of authorized correspondents including an authorized receive-from correspondent list and an authorized send-to correspondent list. Further, when registration and subscription processes are completed, the presence server 106 may keep track of a conference server associated with the client terminal. It should be understood that the client terminal may receive multimedia services from more than one conference server and, in such an embodiment, the user profile stored on the presence server 106 specifies more than one set of conference server's information for each subscription being run on the client device. Further, the presence server 106 is configured to track the state of the user and save that information in the availability records. Further, the user profile may include statistical data associated with one or more subscriptions, and the statistical data may include a time online, and a number of packets sent and received on the client terminal, for example. Further, the user profile may specify restriction states associated with the user. However, it should be understood that the profile illustrated in Table 1 is only exemplary, and more or fewer parameters and records could also be specified in the user profile.

In addition to tracking information associated with individual users, the presence server 106 also receives requests from specific users to activate and deactivate connections to other users associated with instant messaging according to exemplary embodiments. Specific actions and functionality of the presence server 106 will be described in greater detail below.

Further, in a system having more than one conference server, the presence server 106 may be configured to manage the assignment of conference servers to user terminals upon receiving registration and subscription requests from the users. The presence server 106 may be also configured to maintain a state and an availability of each conference server and apply a set of policy rules before assigning a conference server to a user. For example, each user associated with a particular company may be assigned to the same conference server, or the conference server's assignment may depend on user's correspondents. In addition to applying a number of policy rules, the presence server 106 may load-balance the registration and subscription requests between multiple conference servers. It should be understood that many different embodiments are possible and would be readily recognized by those skilled in the art.

Referring back to FIG. 1, the authentication server 110 may include a Remote Authentication Dial-In User Service (“RADIUS”) server that may perform authentication, authorization and accounting functions for users. More information on the RADIUS server may be found in the Request For Comments (“RFC”) document 2138 available from the Internet Engineering Task Force (“IETF”) and incorporated herein by reference. The authentication server 110 may include an internal database or an external database of user profiles or user records that may be accessed by authorized network entities. As will be described in greater detail below, when the signaling server 112 receives a user request for registration or subscription, the signaling server 112 may query the authentication server 110 to determine how to handle the request. According to an exemplary embodiment that will be described in greater detail below, a user profile stored in a database associated with the authentication server 110 may include parameters of one or more services such as a list of correspondents who may contact the user, or a list of correspondents whom the user would like to be able to contact, for instance. According to one exemplary embodiment mentioned in the preceding paragraphs, if the user subscribes with multiple identities, a separate set of lists might be maintained for each identity. The functionality and operation of the authorization server 110 will be described in greater detail below.

Referring back to FIG. 1, the signaling server 112 provides signaling services to the client terminals 102, 114 and other network entities such as the presence server 106, the conference server 108, and the authentication server 110. In one embodiment, the signaling server 112 may include a Session Initiation Protocol (“SIP”) proxy server. However, it should be understood that different embodiments and protocols could also be used. More information on the SIP may be found in the RFC-2543, incorporated herein by reference. According to an exemplary embodiment, the signaling server 112 is an intermediary for signaling messages being sent between client terminals and other network components of the architecture 100. In an embodiment where the signaling server 112 includes a SIP proxy server, the signaling server 110 interacts with the client devices 102 and 114 via a SIP user agent that can reside on a client device or, alternatively, may be implemented as a virtual agent on a network entity. Specific message flows employing SIP messages will be described in reference with subsequent figures. However, it should be understood that different signaling protocols could also be used, and the exemplary embodiments for providing multimedia services, such as instant voice messaging, are not limited to using the SIP.

When a user registers and subscribes to instant voice messaging, a communication session is provisioned between a client/user terminal and the conference server 108. According to an exemplary embodiment, the conference server 108 supports multiple IP addresses and port combinations making them available to authorized users. Referring back to FIG. 1, when users of the client terminals 102 and 114 register and subscribe to the instant voice messaging services, the conference server 108 allocates an IP address/port pair for each communication session created between each client terminal and the conference server 108, and the communication sessions are placed in an inactive (“on hold”) state. According to an exemplary embodiment, the communication session created between the client terminals 102, 114 and the conference server 108 include real-time transport protocol (“RTP”) communication sessions. More information on the RTP may be found in the RFC-1889, incorporated herein by reference. However, it should be understood that the exemplary embodiments are not limited to the RTP, and any currently existing or later developed protocols providing real-time transmission, or time-sensitive transmission, could also be used.

According to an exemplary embodiment, the conference server 108 may be configured to support trascoding between a variety of compression and decompression (codec) schemes that may be utilized by the client terminals 102 and 114. The information required by the conference server 108 to set codec types, and other parameters, are acquired during the set up of RTP sessions, as will be described in greater detail below.

Further, in addition to providing a termination of RTP sessions to client devices and maintaining the session in an inactive state before the activation of sessions, the conference server 108 further bridges the connections internally in order to establish end-to-end RTP sessions between users. According to an exemplary embodiment, the conference server 108 bridges the sessions upon receiving authorized requests from the users, the methods of which will be described in greater detail below.

FIG. 1 illustrates the exemplary architecture 100 suitable for application of the present invention; however, it should be understood that more, fewer, different or equivalent network devices could also be used. Further, those skilled in the art will appreciate that the functional entities illustrated in FIG. 1 may be implemented as discrete components or in conjunction with other components, in any suitable combination and configuration. For example, the exemplary architecture 100 is not limited to a single conference server, and multiple conference servers could also be used to increase the scalability of the multimedia service system. In such an embodiment that will be described in greater detail below, session bridging between users may span two or more conference servers. According to one embodiment, RTP sessions between the conference servers and client terminals may be full-duplex, i.e., allowing bi-directional data transmission on a signal carrier at the same time. In an alternative embodiment, a half-duplex communication, i.e., allowing a bi-directional data transmission on a bi-directional communication link, but not at the same time, may be reinforced when actual voice messages are sent to avoid introduction of echo. In such an embodiment, a conference server may be configured to ensure that the bridge between users is half-duplex.

Hereinafter, the exemplary embodiments will be described in reference to instant voice messaging services. However, it should be understood that the exemplary systems and methods are not limited to the instant voice messaging and could be employed for different services as well.

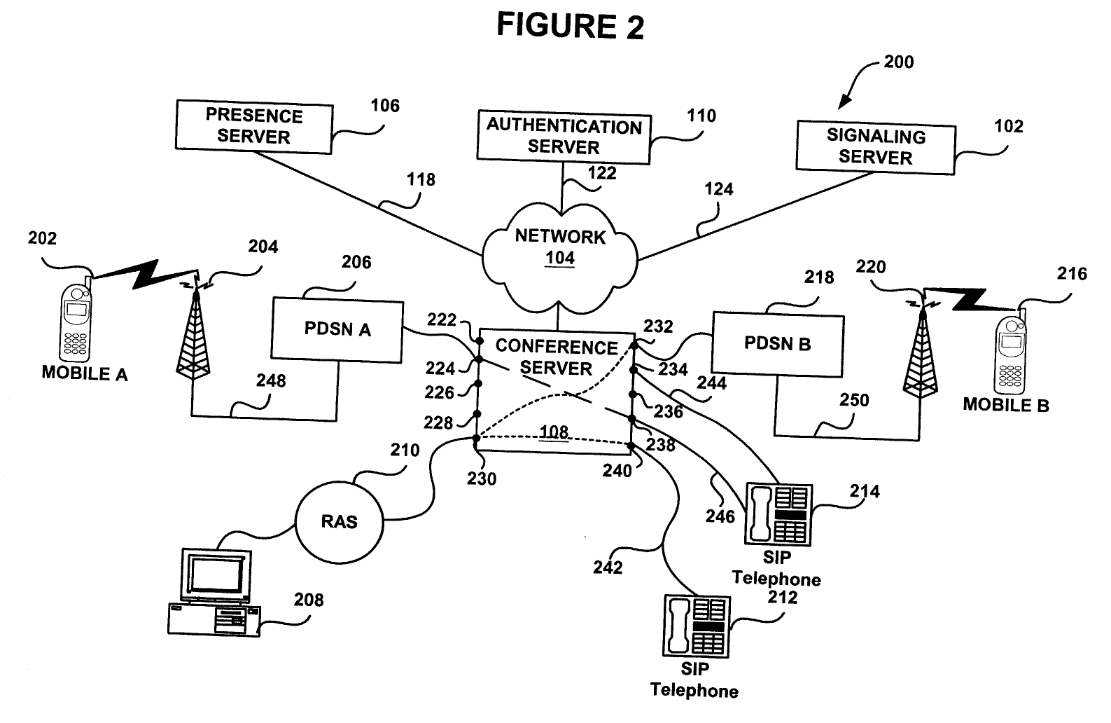

To further illustrate exemplary arrangements, FIG. 2 illustrates a network architecture 200 including different end users having an access to the conference server 108 via a variety of devices. The network architecture 200 includes the conference server 108 providing a number of ports 222-240, depicted as black dots in FIG. 2, to which users may connect and establish RTP sessions. It should be understood that the dots illustrated in FIG. 2 represent IP address/RTP port combinations, where each IP address may be associated with more than one RTP port. Further, the number of port/IP address pairs illustrated in FIG. 2 should not be viewed as limiting, and FIG. 2 illustrates only an exemplary embodiment.

For example, when a user associated with a wireless telephone 202, such as a Code Division Multiple Access (CDMA) telephone, registers with the presence server 106, an RTP session is established between the wireless telephone 202 and the IP address/port combination 224 on the conference server 108. As illustrated in FIG. 2, the wireless telephone 202 accesses 20 the conference server 108 and establishes the RTP session to the conference server 108 via a packet data serving node (“PDSN”) 206 and further via a wireless communication link 248 and a base station 204. FIG. 2 further illustrates a personal computer 208 having an RTP session established to the IP address/port pair 230 via a Remote Access Server (“RAS”) 210, a SIP terminal 212 having an RTP session established to the IP address/port pair 240 on connection 242 (for example, a LAN connection or via an IP service provider), and a wireless client device 216 having an RTP session established to the IP address/port pair 232 via a PDSN 218, a wireless communication link 250 and a base station 220.

FIG. 2 further illustrates an embodiment in which a user may be subscribed with multiple identities, as illustrated in reference to the SIP terminal 212. As mentioned in the preceding paragraphs, a user may wish to have different identities associated with different groups of online users with whom the user is authorized to communicate, and to whom the user's presence (online state) may be sent, the embodiments of which will be described below. In such an embodiment, more than one RTP session is created between such a user and the conference server 108. As illustrated in FIG. 2, the SIP terminal 212 has two RTP sessions created to the IP address/port pairs 234 and 238 on the conference server 108 via the connections 244 and 246.

As illustrated in FIG. 2, connections bridged by the conference server 108 between users might be one-to-one or one-to-many. The one-to-one connection bridging is illustrated with reference to a user associated with the wireless phone 202 that communicates with a user at the SIP telephone 214. According to an exemplary embodiment, when the user associated with the wireless phone 202 specifies who should receive the message, the conference server 108 creates a bridge between the pre-established RTP sessions. Per FIG. 2, the conference server 108 bridges the RTP connections terminating at the IP address/RTP port pair 224 and the IP address/RTP port pair 238. Similarly, the one-to-many connection bridging is illustrated with reference to a user associated with the personal computer 208 that communicates with a user at the SIP telephone 212 and further with a user at the wireless client terminal 216. When the user at the personal computer 208 specifies who should receive the message, the conference server 108 bridges connections between RTP sessions. Per FIG. 2, the conference server 108 bridges the RTP connection terminating at the IP address/RTP port pair 230 to RTP connections terminating at the IP address/RTP port pairs 240 and 232.

According to an exemplary embodiment, when a user decides to send an instant voice message to one or more recipient, the user identifies the intended recipients and initiates instant voice messaging. When a user registers and subscribes to one or more services, the user may receive a list of users with whom the user is authorized to communicate, and the user's presence information (online state) is sent to any online user who is authorized to know the user's presence information. In one embodiment, during the registration, for instance, the user may restrict which users are authorized to know the user's presence information. In such an embodiment, the user may request to have an authorization to communicate with a number of users, but only some of those users may be given an authorization to know the online state of the user. In one embodiment, the authorization server 110 may store a user profile including the list of authorized correspondents as well as other user-specific information. As mentioned in the preceding paragraphs, once the user registers and subscribes to one or more services, the conference server 108 provisions an RTP session to a user terminal.

According to an exemplary embodiment, a user terminal may include a graphical interface configured to display the user's authorized correspondents and further configured to receive user's selections of correspondents to whom the user wishes to send an instant message. Alternatively, a user terminal may be configured to play a list of correspondents to the user and receive selections inputs (such as digits dialed by the user) as means to determine the intended correspondents. However, it should be understood that means by which the user makes the intended correspondents' selection may be application specific, and many different embodiments are possible. Further, once a user selects the list of intended recipients, the user may initiate sending instant voice messages to the intended recipients by selecting a predetermined selection input on a user terminal. For instance, the selection input may include a predetermined button on a user terminal, or a graphical selection identifier that may be selected by the user on the user terminal. It should be understood that different embodiments are possible as well, depending upon the type of a client terminal. Hereinafter, it is assumed that a user selects a predetermined “talk” button to initiate sending instant voice messages to the intended recipients.

Thus, according to an exemplary embodiment, when a user selects a list of intended recipients and selects a talk button on a user terminal, the conference server 108 internally bridges RTP connections between the user and the recipients specified by the user. Since the call set up as well as differences in end user codecs and other device features are resolved ahead of time as part of the registration and subscription processes, when a user selects a talk button, the user instantly sends a real-time voice message to the intended recipients.

The instant voice messaging services according to one exemplary embodiment are delivered to end users by SIP user agents that present output to, and take input from, the user. The embodiments of the message flows that will be hereinafter described are SIP third-party call control flows. A SIP third-party call control employs a mediating entity in the network to invite SIP user agents to join a call. Specifically, the mediating entity initiates the call to the SIP user agents. According to an exemplary embodiment, the mediating entity is the presence server 106, while the call participants are the SIP user agents and the conference server 108. There are a number of possible SIP third-party call flows that can achieve the call setup, and any one of them can be used in the instant voice messaging according to the exemplary embodiments. Therefore, the particular message flows that will be described below are not intended to limit or exclude other embodiments and should only be viewed as illustrative.

Further, it should be understood that the call flows are independent of how a SIP user agent is implemented. The message flows illustrate the setup and control of instant messaging system within the network, and out of the participating user agents. According to exemplary embodiments, end user terminals can either locally host or remotely control the SIP user agent. As will be described in greater detail below, a SIP virtual user agent employs a remotely controlled SIP user agent to deliver instant voice message services to non-SIP user terminals, thus, allowing the service to migrate with evolving networks. In such an embodiment, the components and methods between actual SIP user agents may remain constant as the network evolves, and the hosting of the SIP user agent may change to accommodate the evolving networks.

Each subsequent figure illustrating call flows includes two SIP user agents (UA-A 370 and UA-B 372), an authorization server such as the authorization server 100, a presence server such as the presence server 106, and a signaling server such as the signaling server 112, and two conference servers (CONF. SERVER 1 (108) and CONF. SERVER N (374)), where “N” indicates an arbitrary number of conference servers. Further, the subsequent figures will be illustrated in reference to users associated with terminals 202 and 214 illustrated in FIG. 2. In such an embodiment, each user may register with a predetermined registration identity, while the user associated with terminal hosting the UA-B 317 is associated with two subscription identities such as a work title identity and a personal identity. While SIP is the primary protocol for setting up session, the message flows illustrated in subsequent figures include non-SIP protocol elements. For example, the signaling server 112 and the authorization server 110 may communicate using non-SIP protocols such as a proprietary protocol or RADIUS. The protocols used in the message flows described below are proprietary protocols. However, it should be understood that standard protocols could also be used.

Further, while not shown explicitly, the basic call flows can be easily generalized to the case of a single user subscribing with multiple identities, and the case of a single message being sent simultaneously to multiple recipients. Similarly, the subsequent message flows do not address failure cases. Therefore, it should be understood that the subsequent figures should not limit or restrict the scope of specific capabilities, services or features of the instant voice messaging according to the exemplary embodiments. Further, it should be understood that the steps of subscription and registration may be combined into a single step.

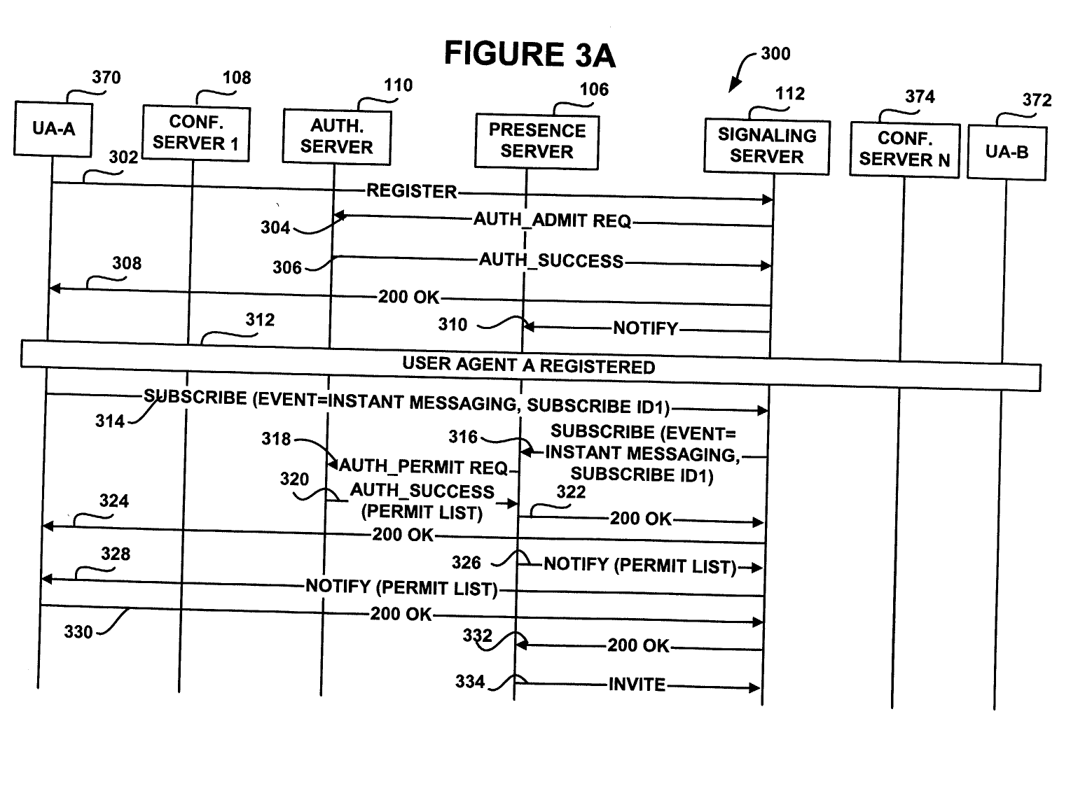

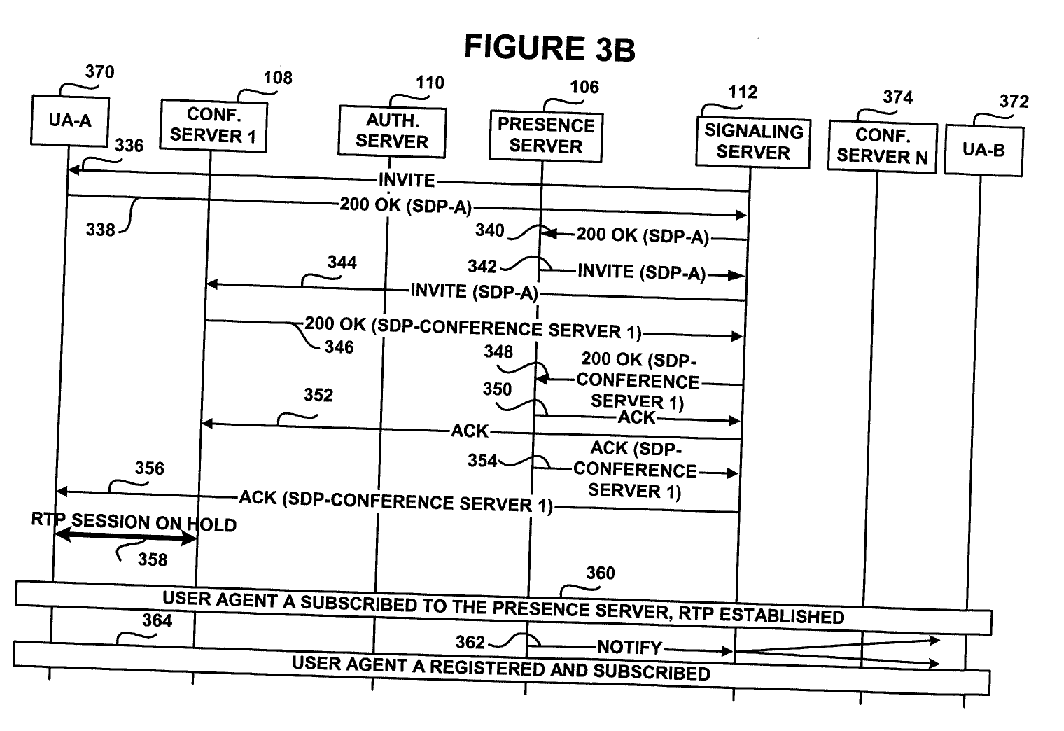

FIGS. 3A and 3B illustrate a message flow 300 for a SIP user registration and subscription to instant voice messaging services according to one exemplary embodiment. Referring to FIG. 3A, the SIP user agent A (UA-A) 370 sends a registration request (REGISTER) message 302 to the signaling server 112. According to an exemplary embodiment, a user registers with a predetermined user registration identifier. Responsive to receiving the registration request, the signaling server 112 generates an authentication admission request (AUTH_ADMIT REQ) message 304 and forwards it to the authentication server 110. To authenticate the user, the authorization server 110 retrieves a user profile including information specifying the services that the user is authorized to use, information related to user preferences, etc.

When the authorization server 110 successfully authenticates the user, the authorization server 110 returns an authentication successful (AUTH_SUCCESS) message 306 to the signaling server 112. Signaling server 112 then sends a 200 OK message 308 to UA-A 370. When the user is successfully authenticated, the signaling server 112 generates a notification (NOTIFY) message 310 and forwards it to the presence server 106. The notification message 310 notifies the presence server 106 that the user, represented as the UA-A 370, is authenticated and authorized to register with the presence server 106, thus, completing the user registration as illustrated in a status bar 312. It is assumed, that the AUTH_ADMIT REQ message 304 and the AUTH_SUCCESS message 306 are part of a protocol between the presence server 106 and the authorization server 110.

To subscribe to one or more services, the UA-A 370 sends a subscription request (SUBSCRIBE) message 314 to the signaling server 112. The request message 314 specifies the type of service being subscribed to, in this embodiment, an instant messaging service, and further specifies a subscription identifier selected by the user, in this example, a subscriber ID1. When the signaling server 112 receives the message 314, the signaling server 112 forwards the message to the presence server 106, as illustrated in 316. Subsequently, the presence server 106 sends an authentication permission request (AUTH_PERMIT REQ) message 318 on behalf of the user, and forwards the message to the authorization server 110. Next, the authorization server 110 determines whether the user is authorized using a user profile stored in one of its databases, and, assuming a successful authorization, returns an authorization successful (AUTH_SUCCESS) reply message 320 to the presence server 106. According to an exemplary embodiment, the reply message includes an authorized correspondent list shown as a “permit list” parameter in FIG. 3A. The authorized correspondent list includes a list of correspondents determined based on the user's specification, permission, and authorization as stored by the server 110. The presence server 106 subsequently sends to the signaling server 112, a 200 OK message 322 indicating a successful processing of the request, and the signaling server 112 forwards the message to the UA-A terminal 370, as illustrated in message 324. It is assumed that both the AUTH_PERMIT message 318 and the AUTH_SUCCESS message 320 are part of a protocol employed between the presence server 106 and the authentication server 110.

According to an exemplary embodiment, the presence server 106 updates the authorized correspondents to include only those users currently on line. As illustrated in FIG. 3A, the presence server 106 sends the updated list in a notification (NOTIFY) message 326 to the signaling server 112 that subsequently forwards it to the UA-A terminal 370, as illustrated in 328. The notification message 326 provides information which authorized correspondents are online. The UA-A 370 responds with a 200 OK message 330 to the signaling server 112 that, subsequently, forwards the message to the presence server 106, as shown in 332. According to an exemplary embodiment, at this point of the registration process, the user preferably does not employ the correspondents list since the registration/subscription process has not completed. In an exemplary embodiment, the user interface program on a client terminal may be configured not to use the services until the process completes.

Subsequently, the presence server 106 sends an INVITE message 334 to the signaling server 112 that forwards the message to the UA-A 370, as illustrated in FIG. 3B in a message 336. The UA-A 370 responds with a 200 OK message 338 including its Session Description Protocol (SDP) parameters, illustrated as SDP-A in the message 338. More information on SDP may be found in the RFC-2327, incorporated herein by reference. According to an exemplary embodiment, SDP parameters in the message 338 include an IP address and ports for the user agent's end for RTP sessions. Additionally, SDP parameters may include a list of supported codecs. When the signaling server 112 receives the message 338, it forwards the message to the presence server 106 as illustrated in 200 OK message 340.

Subsequently, the conference server 108 is invited to the call. According to an exemplary embodiment, the presence server 106 sends invite 342 to signaling server 112, and signaling server 112 sends to the conference server 108 an INVITE message 344 including the SDP associated with the UA-A 370. The conference server 108 responds to the signaling server 112 with a 200 OK message 346 including an SDP associated with the conference server 108, SDP-Conference Server 1, as illustrated in FIG. 3B. The SDP-Conference Server 1 includes the IP address and ports for the conference server's end of the RTP session. Additionally, the SDP-Conference Server 1 may include a codec selected by the conference server 108 from a list of codecs provided by the UA-A 370. When the signaling server 112 receives the message 346, it forwards the message to the presence server 106, as illustrated in 348.

Responsively, the presence server 106 sends acknowledgement (ACK) messages to the conference server 108 and the UA-A 370 via the signaling server 112 as illustrated in messages 350, 352, 354, and 356. The ACK message 354, 356 to the UA-A 370 include the SDP associated with the conference server 108. At this point, an RTP session is set up between the UA-A 370 and the conference server 108, as illustrated in 358 and a status bar 360. According to an exemplary embodiment, the RTP session is in an inactive state (or an “on hold” state).

Further, according to exemplary embodiments, when the UA-A 102 is fully subscribed to the presence server 106 and has an RTP connection established to the conference server 108, the presence server 106 notifies other subscribers who wish to, and are authorized to, be notified when this newly-subscribed user comes online. As illustrated in FIG. 3B, the presence server 106 sends one or more NOTIFY messages 362 via the signaling server 112. According to an exemplary embodiment, a user incorporating the UA-A 370 is fully registered and subscribed, as illustrated in a status bar 364, and may send messages to users on his/her authorized correspondent list, and receive messages from any other users who are authorized to send the message to that user. As mentioned in the preceding paragraphs, a user interface on a client device is configured to provide means for providing information to the user, such as displaying the user's correspondents list, and receive inputs from the user, such as a “talk” input, or correspondent selection.

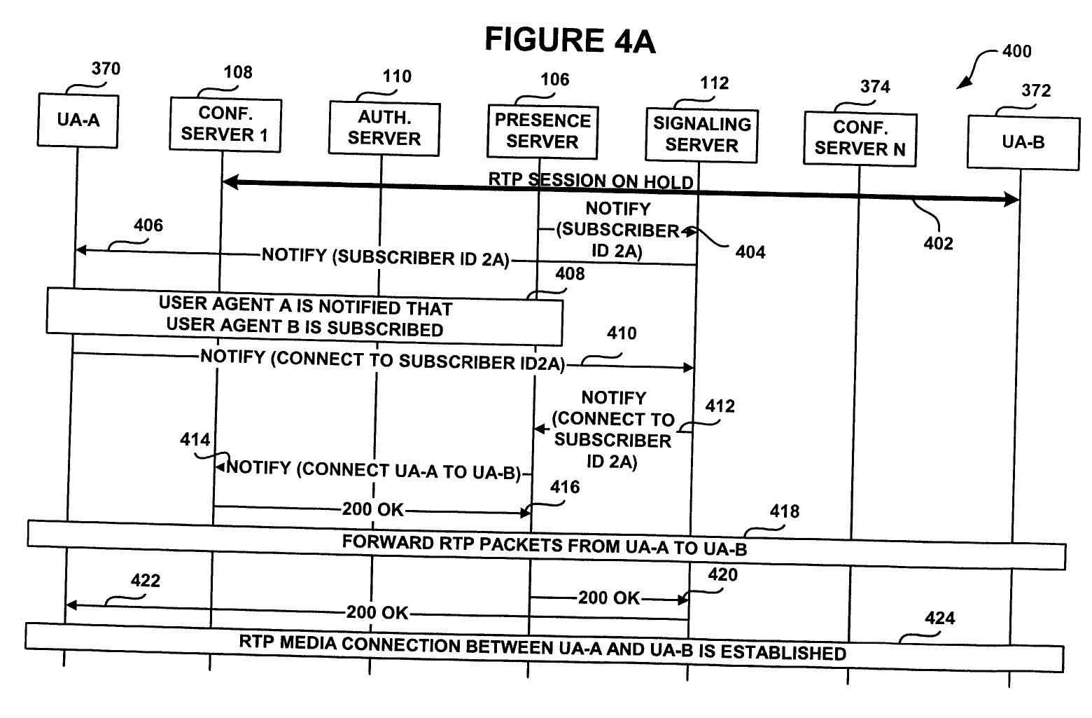

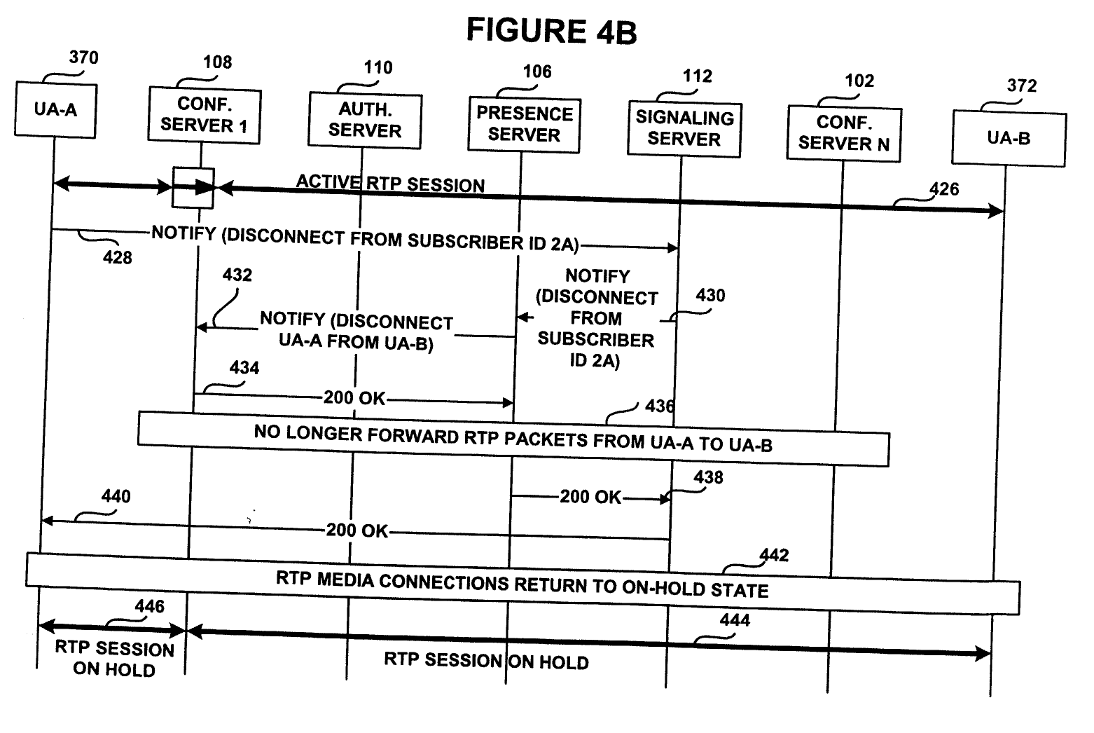

FIGS. 4A and 4B illustrate a message flow 400 for creating an active connection between users and sending an instant voice messages when both a sender and a receiver have RTP sessions established to the same conference server. It is assumed that the users are registered and subscribed according to the method described in reference to FIGS. 3A and 3B, and that the sending user is authorized to contact the receiving user or users. The sending user is represented as the UA-A 370, and a single receiving user is represented as UA-B 372.

Referring to FIG. 4A, it is assumed that the UA-B 372 has registered and subscribed to a service, and an RTP session has been established between the UA-B 372 and the conference server 108, as illustrated in 402. A user associated with the client terminal 372 may have two or more subscription identifiers such as subscriber ID 2a and 2b. It should be understood that a user may select a predetermined subscriber identifier via a client terminal using, for example, graphical selection inputs, or by dialing predetermined digits. In such an embodiment, if the user has more than one subscriber identifier, the user may activate/deactivate some of them as the services are provided to the subscriber. In FIGS. 4A and 4B, it is assumed that the user associated with the UA-A 370 is authorized to communicate and receive online status information associated with the user having the subscriber ID 2a. As shown in FIG. 4A, the last step in the registration procedure of UA-B is to notify authorized users that UA-B is now on line. Specifically, the presence server 106 sends via the signaling server 112 to the UA-A 370 a notification (NOTIFY) message including information that the user associated with the subscriber ID 2a is online and ready to receive messages, as illustrated in messages 404, 406. The sequence of 404 and 406 is analogous to the notify 362 of FIG. 3B that concluded subscription procedure for UA-A 370. Once the UA-A 370 receives the NOTIFY message 406, the UA-A 370 is notified that the UA-B 372 is subscribed as illustrated in a status bar 408.

Subsequently, UA-A 370 requests a connection to the UA-B, subscriber ID 2a. For example, the user may select the destination user via a graphical interface available on a user terminal and may further depress a “talk” button to initiate a connection. As illustrated in FIG. 4A, the UA-A 370 sends to the presence server 106 via the signaling server 112 a notification (NOTIFY) message, as illustrated by messages 410 and 412. The NOTIFY messages 410 and 412 define the subscriber ID 2a associated with the destination user. When the presence server 106 receives the request, the presence server 106 checks the status associated with a user of the UA-B 372. According to an exemplary embodiment, the status information is locally maintained on the presence server 106, and indicates whether the user associated with the UA-B 372 is registered and subscribed, and, further, whether the user associated with the UA-A 370 is authorized to send messages to that user. Further, the presence server 106 may verify whether the destination user is presently in a state that allows receiving a message. For example, the presence server 106 may determine whether the destination user is currently receiving a message. It should be understood that the presence server 106 may also determine other aspects before connecting the sessions.

If the presence server 106 determines that the connection is permitted, the presence server 106 reissues a NOTIFY message 414 to the conference server 108. The message 414 identifies the endpoints by their user agents, UA-A and UA-B, and may include an indication of which pair of IP addresses/RTP port combinations to bridge. Further, according to an exemplary embodiment, the presence server 106 updates the status of the sending and receiving users and their respective user agents. It should be understood that, according to an exemplary embodiment, user agents are not aware of a local IP address and an RTP port associated with the destination entity. Alternatively, they have the knowledge of IP address and RTP port on the conference server 108. When the conference server 402 bridges the RTP connections between the UA-A 370 and an appropriate RTP session associated with the UA-B 372, the conference server 108 responds with a 200 OK message 416, and the conference server 108 may forward RTP packets between the UA-A 370 and the UA-B 372, as indicated by status bar 418.

Subsequently, the presence server 106 sends via the signaling server 112 to the UA-A 370 a 200 OK message, as indicated by 420 and 422, and an RTP connection is established between the UA-A 370 and the UA-B 372, as indicated by a status bar 424. The receipt of the 200 OK message 422 on the UA-A 370 is translated into a signal to the end user, such as a beep at the client terminal. In an exemplary embodiment, it is assumed that the user continues to hold down the “talk” button.

According to an exemplary embodiment, at this point of the process, an RTP connection between the UA-A 370 and the UA-B 372 is bridged, and RTP packets can flow between the users. In the embodiment in which a user employs a “talk” button, the connection is maintained as long as the “talk” button remains depressed, as illustrated in 426 in FIG. 4B. However, it should be understood that different embodiments are possible as well. For example, more than one selection input may exist on a client terminal to initiate a session and to terminate a session. Those skilled in the art will realize that many different application-specific embodiments are possible as well.

FIG. 4B further illustrates the process of terminating the communication link between the UA-A 370 and the UA-B 372. According to one exemplary embodiment, the user may terminate the communications by releasing the “talk” button on his/her client terminal. Responsive to detecting the user input, the UA-A 370 sends a NOTIFY message to the presence server 108, as indicated by messages 428 and 430. The NOTIFY messages identify the terminating user with the subscriber ID 2.

Subsequently, the presence server 106 reissues a NOTIFY message 432 to the conference server 108, again translating the incoming message to indicate which user agents to disconnect. The NOTIFY message 432 may include the IP address/port combinations associated with the session. According to an exemplary embodiment, the conference server 108 terminates the internal connection between the corresponding IP address/RTP ports as illustrated in 436, and sends a 200 OK message 434 to the presence server 106. Responsively, the conference server 108 updates the status of the sender user and the receiver user. Further, the presence server 106 sends a 200 OK message 438 to the UA-A 370 via the signaling server 112, as illustrated in messages 438 and 440. When the UA-A 370 receives the message 440, the UA-A 370 translates the message into a signal to the end user such as a beep at the client terminal indicating a termination of the connection.

As shown in 442, RTP sessions return to an inactive state. Further, as shown at 444, the RTP sessions of the sending user agent and the receiving user agent return to an inactive state, and the RTP sessions 444 and 446 to the conference server 108 are maintained at the end of the sequence so that the users are still able to instantly activate the sessions.

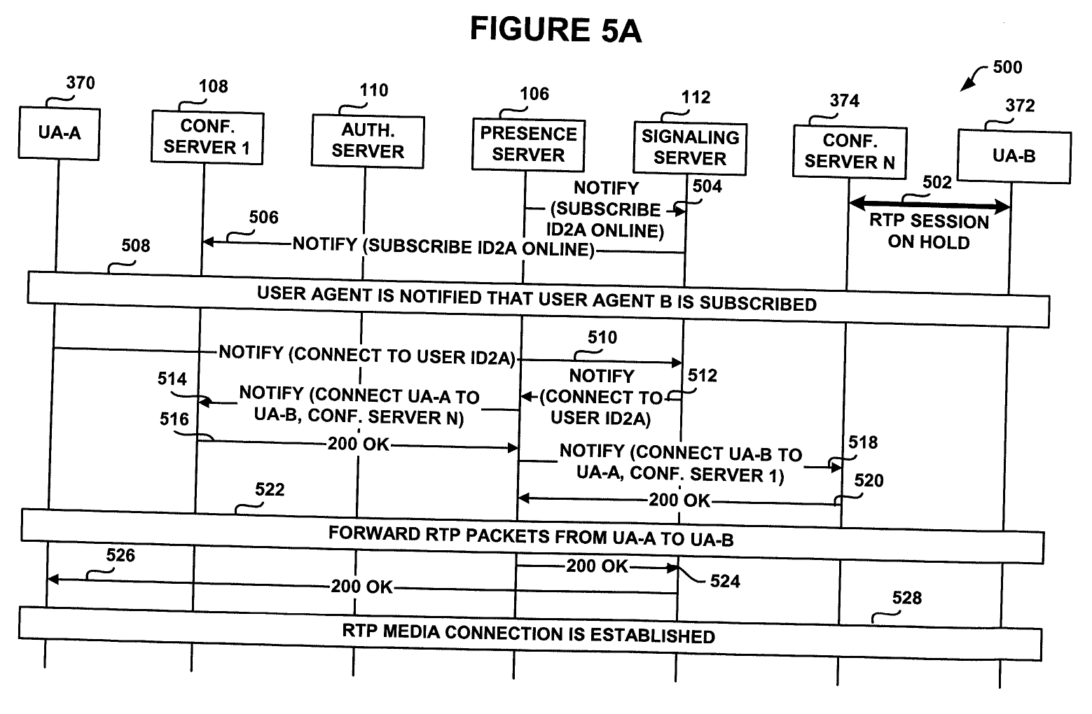

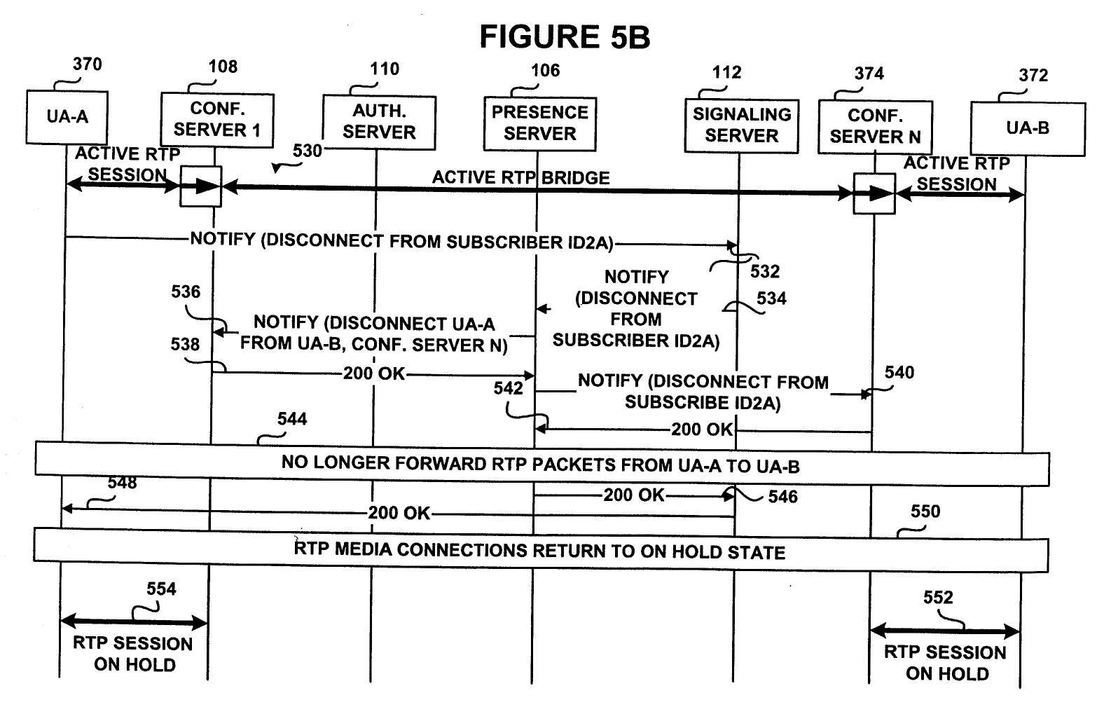

FIGS. 5A and 5B are a message flow illustrating how a signaling user agent uses the voice messaging service to create an active connection to another online user, and sends an instant voice message when both sender and receiver(s) have RTP sessions established to different conference servers. It is assumed that user A and user B are registered and subscribed according to the steps described in FIGS. 3A and 3B,and that the sending user is authorized to contact the receiving user(s). Further, FIGS. 5A and 5B do not intend to illustrate an entire process of registration for user B; however, the last few steps of the registration are illustrated in FIG. 5A. Similarly to the preceding figures, the sending user is represented with the UA-A 370 and a single receiving user is represented with the UA-B 372. As illustrated in FIGS. 5A and 5B, a user associated with the UA-B registers, subscribes to an instant voice messaging service, and an RTP session is established to the conference server N 374, as shown in 502. Further, similarly to the preceding figures, it is assumed that the user associated with the UA-B 372 has multiple subscriber identifiers, and that the UA-A is authorized to communicate with the subscriber having ID 2a. As shown in messages 504, 506 the UA-A 370 receives a NOTIFY message including information related to the on-line status associated with the subscriber, identity ID 2a, and the UA-A 370 is notified that the UA-B 372 is subscribed, as illustrated by a status bar 508.

Similarly to FIG. 4A, it is assumed that the user associated with the UA-A 370 requests a connection to be established to a subscriber associated with the subscriber identifier 2a at the UA-B 372. The steps of sending a connection request are illustrated with messages 510 and 512. According to an exemplary embodiment involving multiple conference servers, the presence server 106 sends separate NOTIFY messages to each conference server involved in the connection request. The presence server 106 may translate the subscription identifier specified in the connection request message to respective user agents and conference servers.

As illustrated in FIG. 5A, the presence server 106 sends to the conference server 108 a NOTIFY message 514 including a request to bridge a connection between the UA-A 370 and the UA-B 372 associated with the conference server N 374. Responsively, the conference server 108 receives a 200 OK message 516. Similarly, the presence server 106 sends to the conference server 374 a NOTIFY message 518 including a request to connect the UA-A 370 with the UA-B 372, and further specifying that the UA-A 370 is associated with the conference server 108. Subsequently, the presence server 106 receives a 200 OK message 520 from the conference server 374, and the conference server 108 may forward RTP packets from the UA-A 370 to the UA-B 372, as illustrated by a status bar 522. According to an exemplary embodiment, the connection between two or more conference servers is established in such a way so that it is transparent to the presence server 106, except for sending multiple NOTIFY messages and receiving multiple 200 OK messages.

When the presence server 106 receives the 200 OK messages 516 and 520 from the respective conference servers, the presence server 106 sends a 200 OK message to the UA-A 370 via the signaling server 112, as illustrated in messages 524 and 526. As illustrated by a status bar 528, the RTP connection between the UA-A 370 and the UA-B 372 is now up. Similarly to the single conference server embodiment illustrated in FIGS. 4A and 4B, the conference servers bridge the connections between the UA-A 370 to the UA-B 372 with the difference that the bridge between the sender and the receiver spans multiple conference servers, as illustrated in 530. In one embodiment, the conference servers may enforce a half-duplex bridge from the UA-A 370 to the UA-B 372. However, different embodiments are possible as well. Further, as discussed in reference to the preceding figures, the user associated with the UA-A 370 may be notified that the connection is established.

When the user disconnects the session, the UA-A 370 sends a NOTIFY message to the presence server 106 via the signaling server 112, as illustrated in 532 and 534. When the presence server 106 receives the message 534, it initiates a disconnection process from the conference servers. The process of disconnecting the call is accomplished by sending separate NOTIFY messages to each conference server involved in the disconnection request. Similarly to bridging the sessions, the presence server 106 may specify which user agents should be disconnected. Messages 536 and 538 illustrate a disconnection request being sent to the conference server 108, and messages 540 and 542 illustrate a disconnection request being sent to the conference server 374. Similarly to bridging RTP sessions via multiple conference servers, the termination of the bridge may be transparent to the presence server 106, except for multiple 200 OK messages being received in response to the disconnection requests. When the bridged connection is terminated, as illustrated by a status bar 544, the presence server 106 sends a and 548, and the RTP sessions return to an inactive (or “on hold”) state, as illustrated by a status bar 550. As illustrated in FIG. 5B, the RTP sessions 554 and 552 remain in an inactive state between the UA-A 370 and the conference server 108, as well as the UA-B 372 and the conference server 374.

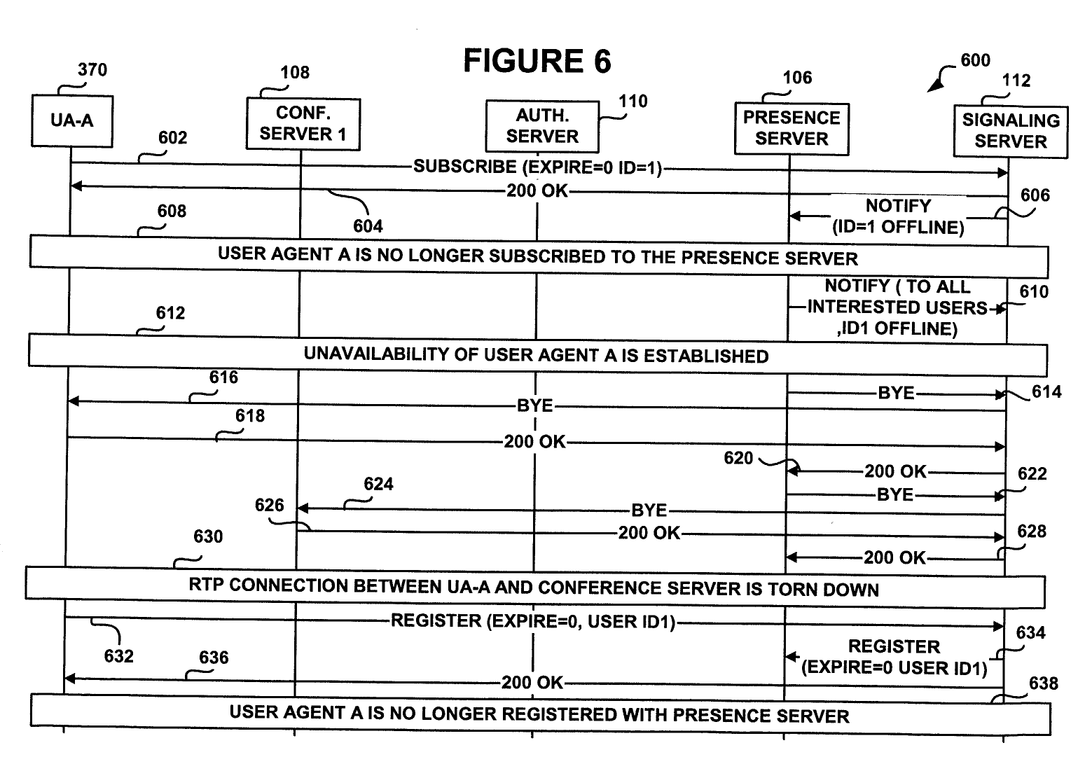

FIG. 6 is a message flow 600 illustrating a process for un-subscription to and deregistration from an instant voice messaging service according to one exemplary embodiment. According to an exemplary embodiment, a user may unsubscribe to the service using a client terminal. For example, a client interface on the client terminal may include a selection input that enables the user to initiate a process that unsubscribes the user from the service. When the user decides to unsubscribe to and/or deregister from the service, the UA-A 370 sends to a signaling server 112 a SUBSCRIBE message 602 including an expire parameter set to zero. The message 602 further includes the subscription ID (in this example, subscription ID 1 associated with the user of the client terminal 202). The signaling server 112 responds with a 200 OK message 604, and, then, issues a NOTIFY message 606 to the presence server 106 indicating an offline status for the subscription ID 1 associated with the user of the client terminal 202.

According to an exemplary embodiment, when the presence server 106 receives the NOTIFY message 606, the presence server 106 removes the user's specific subscription from its list of online users, as illustrated in a status bar 608, and sends a NOTIFY message 610 to all online users previously notified when that user came online. Using this process, the presence server 106 establishes unavailability of the UA-A agent 370, as illustrated by a status bar 612. It should be understood, that the presence server 106 may also update other local state information associated with the UA-A 370.

Next, the presence server 106 sends a BYE message to the UA-A 370 via the signaling server 112 for the call ID associated with the subscription ID, as illustrated in 614 and 616. This causes the user agent to exit the call. The user agent responds with a 200 OK message that is sent via the signaling server 112 to the presence server 106, as illustrated in 618 and 620. Subsequently, the presence server 106 sends a BYE message to the conference server 108 via the signaling server 112, as illustrated in 622 and 624. This causes the conference server 108 to exit the call. The conference server 108 responds with a 200 OK message that is sent to the presence server 106 via the signaling server 112, as illustrated in 626 and 628. At this point, the RTP session between the UA-A 202 and the conference server 108 has been torn down, as illustrated by a status bar 630.

To deregister the user, the UA-A 202 sends to the signaling server 112 a REGISTER message 632 including the expiration parameter set to zero. Further, the message 632 includes the registration ID as specified in the account established for the user on the presence server 106 or the authentication server 110. The signaling server 112 forwards the REGISTER message 632 to the presence server 106, as illustrated in 634, and the presence server 106 responds with a 200 OK message 636. The presence server 106 updates any relevant local information such as registration account information associated with the user, and the user is no longer registered with the presence server 106, as illustrated by a status bar 638. It should be understood that the process of de-registration and de-subscription may be initiated by the presence server 106. For example, the presence server 106 may be configured to time the inactivity status associated with a connection, and when a predetermined time-out is reached, the conference server 106 may tear down the connection. It should be understood that different embodiments are possible as well.

It should be understood that message flows illustrated in FIGS. 3-6 are only exemplary, and the present invention is not limited to the illustrated messages. It should be understood that fewer, more, different, or equivalent messages could also be used. Further, in the message flows presented above, the signaling agents, such as SIP user agents act on behalf of the end user to access and use instant voice messaging according to the exemplary embodiments. In the illustrated embodiments, the SIP user agent resides on an end-user client terminal, such as a telephone or a personal computer. However, according to exemplary embodiments, a non-SIP client terminal may also communicate with a remote signaling user agent, which participates in the instant messaging service. In such an embodiment, the SIP user agent could reside in a network component and be remotely controlled by a non-SIP client device. In such an embodiment, the SIP user agent has a virtual presence on a client device. Hereinafter, a remotely residing SIP user agent will be referred to as a virtual user agent (“VUA”).

According to an exemplary embodiment, in addition to basic components associated with the SIP user agent, the VUA configuration includes two additional components. Specifically, those components include a remote control protocol and interface, and a media transport function. The remote control protocol and interface provides a method for remotely executing programs to exchange command and control messages with the SIP user agent. The command and control messages cause the SIP user agent to participate in the call control process of instant voice messaging on behalf of the client device. For example, among other components, the protocol may include methods for the client device to instruct the SIP user agent to register and subscribe with the service, and request a connection to another user.

According to an exemplary embodiment, the protocol employed between the non-SIP terminal and a VUA could be based on a type of transactions, and could utilize any currently existing or later developed protocols. Further, the protocol may be device-specific, and a VUA may be customized according to the capabilities and methods employed by the client device. Further, different client devices may employ different protocols to communicate with a VUA, and the VUA may be customized to recognize and process different types of protocols depending on the type of the device employing the VUA. Alternatively, applications on client devices may be customized to ensure conformance with a specific implementation of the control protocol and interface at the VUA. It should be understood, that a VUA is not limited to the use with the instant voice messaging according to exemplary embodiments, and different applications, which depend on a signaling protocol such as SIP could be implemented with a VUA, as well.

According to an exemplary embodiment, the media transport function available on a VUA ensures that the SIP user agent forwards media data between the client devices and other network devices involved in providing instant voice messaging or other services. According to an exemplary embodiment, media payload in RTP packets arriving from the conference server 108 are forwarded to the client device for playout to the end user. Similarly, media data arriving from the client device at the SIP user device are sent to the conference server 108 in the payload of the RTP packets. According to an exemplary embodiment, the media transport functions may depend upon the media processing methods used on the client device. For example, if the client device has the ability to generate RTP packets, the transport function may forward RTP packets. Alternatively, if the client device generates raw codec samples, the transport function creates RTP packets and inserts the samples into the payload. Similarly, the payload of arriving RTP packets may be extracted and forwarded to the client device as raw codec samples.

According to an exemplary embodiment, the transport function may involve customization of the VUA according to the capabilities and methods of the client device. Conversely, customization of the client device might be required to ensure conformance with a specific implementation of the transport function at the VUA. It should be understood that the VUA is not limited to the use with instant voice messaging services described herein, and could support other network services and end-user applications.

With the addition of the remote control protocol, the interface and the media transport function to the SIP user agent, a non-SIP client device may view the SIP user agent as a VUA. The exact nature of the application that executes on the client device and accesses the services and functions of the VUA depends upon the specific device. The methods described hereinafter and including the VUA are intended to encompass applications and implementations of instant voice messaging according to an exemplary embodiment. The call flows presented in the previous figures as well as the subsequent figures are accessible to any client device, regardless of whether the SIP user agent resides on the device or is accessed as a VUA. The concept of the VUA is intended to ensure that end user's experience in using instant voice messaging does not depend upon how this functionality is implemented.

Subsequent figures illustrate three embodiments of instant voice messaging in wireless access networks. In figures illustrating a VUA, the control protocol used between a client device and the VUA is shown for illustrative purposes only. It should be understood that the illustrated control protocol are only exemplary and should not be viewed as limiting.

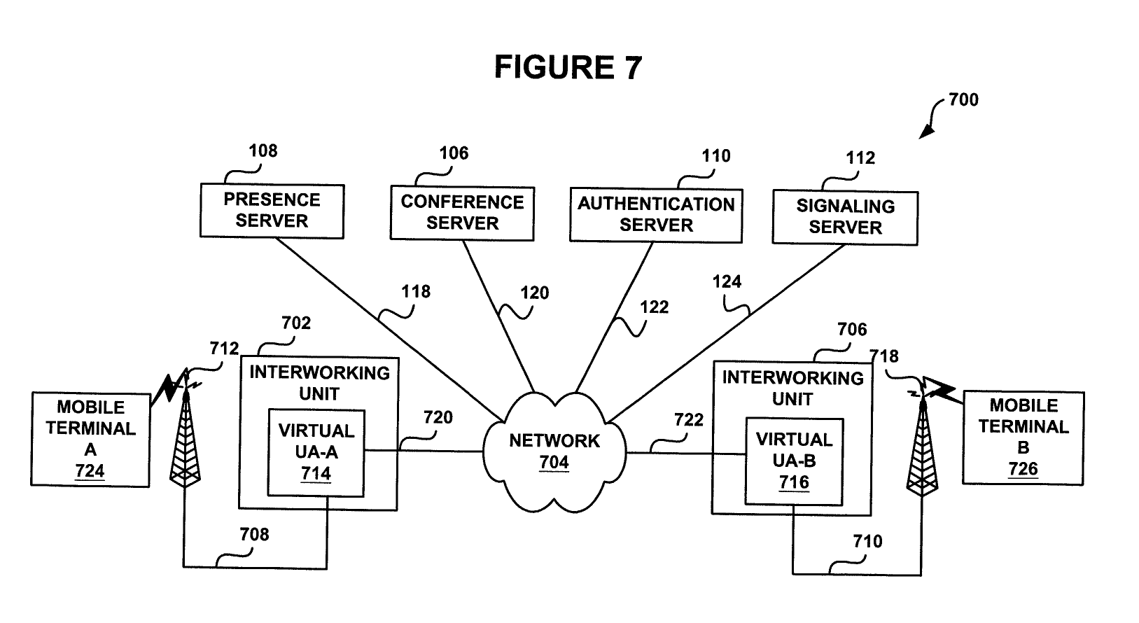

FIG. 7 is a block diagram illustrating a network architecture 700 for providing instant voice messaging to a client device in a second generation (2G) network, in which a VUA is configured as a remote device, and client devices are non-SIP terminals. The network architecture 700 includes two subscriber devices depicted as wireless terminals 724 and 726. However, it should be understood that the subscriber devices could take other forms as well. The wireless terminals 724 and 726 access a network 704 via interworking units (“IWUs”) 702 and 706 and base stations 712 and 706, respectively. In one embodiment, the wireless terminals 724 and 726 connect to the network 704 via Point-to-Point Protocol (“PPP”) connections 708 and 710 established to the IWUs 702 and 706. It is understood by those of skill in the art that connections 708 and 710 may make use of typical wireless network infrastructure components to establish and support the PPP connection. In one embodiment, the wireless terminals may be configured to receive and transmit codec samples. Alternatively, the terminals may be configured to support RTP flows. If the terminal client device supports only a codec transport methods, the device may buffer the samples and appropriately sequence the samples for playout to a user. FIG. 7 further illustrates the presence server 108, the conference server 106, the authentication server 110 and the signaling server 112 connected to a network 704.

In the embodiment illustrated in FIG. 7, the PPP connections from the wireless terminals 724 and 726 may be terminated on the network end as RAS sessions hosted by the IWUs 702 and 706. To establish such connections, a user may enable an IP data mode on the wireless terminal, for example. However, different embodiments are possible as well. Further, as illustrated in FIG. 7, VUAs labeled as Virtual UA-A 714 and Virtual UA-B 716 are implemented on IWUs 702 and 706, respectively. In such an embodiment, the wireless terminals 724 and 726 may run mobile applications that interface with respective VUAs at the other end of the PPP connections. According to an exemplary embodiment, a mobile application provides a user interface to instant voice messaging features and functions, such as registration, subscription, display of the user's correspondents list, and a “talk” button or a different interface. Further, the mobile application may include the functionality to route voice codec output to the IP data path, and to receive media data from the incoming IP packets and route them to the voice codec.

In one embodiment, the wireless terminals may transport codec samples in IP packets to the VUAs 714 and 716 that may subsequently create RTP packets by inserting the codec samples into the RTP payloads. Next, the VUAs 714 and 716 may transport the RTP packets to the conference server 106 over established RTP sessions. In such an embodiment, the RTP stream is terminated on the IWUs 702 and 706, which host the VUAs 714 and 716. For the network-to-terminal direction, the steps are reversed. In FIG. 7, the IWUs 702 and 706 are connected to the network 704 via connections 720 and 722 that, according to an exemplary embodiment, among other protocols, support RTP, SIP and IP flows.

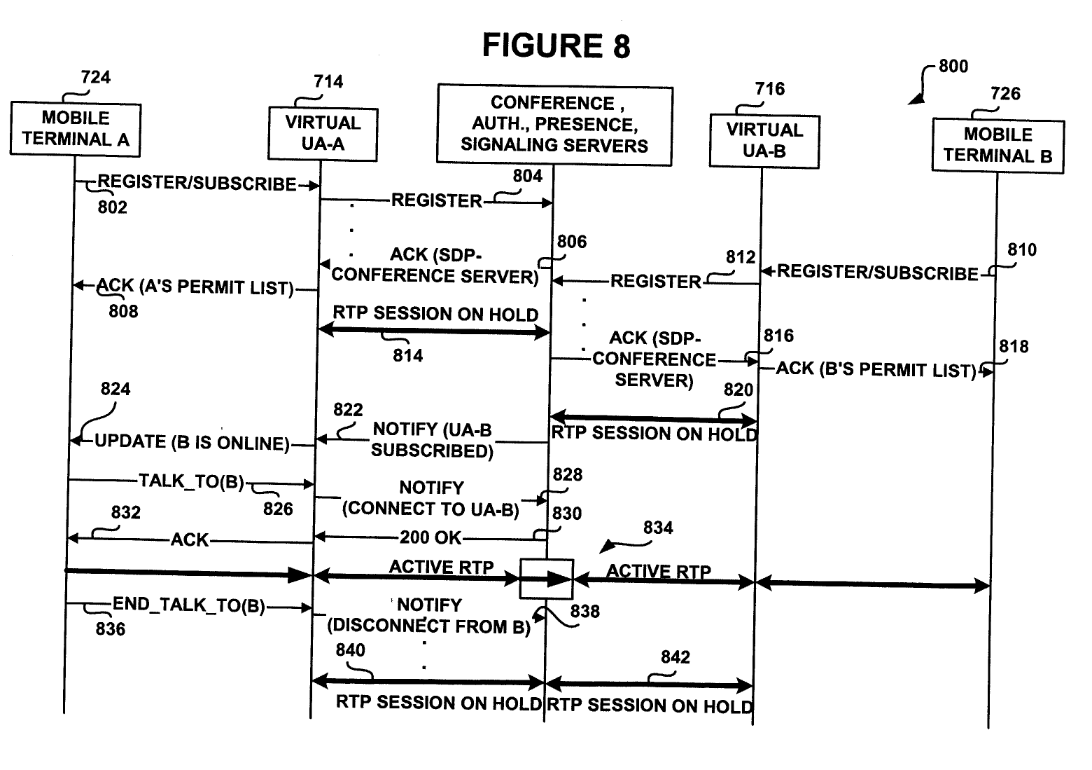

FIG. 8 is a message flow 800 illustrating registration/subscription and instant voice messaging in the system architecture of FIG. 7. In FIG. 8, the communication between the mobile terminals 724 and 726 and the VUAs 714 and 716 employ a pseudo-protocol that may take different embodiments from the ones illustrated in FIG. 8. The messages are descriptive, but should not be understood as employing a specific type of protocol.

As illustrated in a message 802, the mobile application 724 sends registration and subscribe messages to the VUA 714. In one embodiment, the mobile terminal associated with the mobile application 714 may first complete a power-on sequence, and the user may then establish a data mode connection via PPP. In FIG. 8, separate register and subscribe messages are merged into one message 802. However, it should be understood that many different embodiments are possible, in which two different messages could be sent. Receipt of this request on the VUA-A 714 triggers the Register/Subscribe call flows presented above, and culminate with an ACK message 806 from the presence server 106. As illustrated in FIG. 8, the message 806 includes a conference server's SDP, and all servers are depicted as a single block. The ACK message 806 further indicates a completion of a set up of an inactive RTP session between VUA-A 714 and the conference server 108, as indicated in 814. Further, when the VUA-A 714 receives the ACK message 806, the VUA-A 714 generates and sends to the Mobile Application A 202 an Ack message 808 including the authorized correspondents list (acquired by the VUA-A 714 during the call flow set up). According to an exemplary embodiment, the VUA-A 714 is now online and ready, and the Mobile App A 724 is also ready to use the instant voice messaging services.

As further illustrated in FIG. 8, the mobile application B 726 initiates the same sequence, which results in the VUA-B 726 coming online, and the mobile application B 726 entering a ready state as well. The exemplary process is illustrated with messages 810, 812, 816, 818, and an RTP session on hold 820. Upon the completion of the registration and subscription process by the mobile application B 726, the mobile application A 724 receives a notification that the mobile application B 726 is online. To do that, the presence server 106 sends a NOTIFY message 822 to the VUA-A 714 that may subsequently notify the authorized users. In FIG. 8, the VUA-A 714 sends an Update message 824 to the mobile application A 724, which may alert the end user that user B is online.

Further, as illustrated in FIG. 8, a user associated with the terminal 724 initiates an instant voice message to user B by depressing a “talk” button, for instance. In such an embodiment, the mobile application 724 may be configured to respond by sending a Talk_To message 826 to the VUA-A 724, indicating a request to bridge a connection to the user B. This, subsequently, may trigger the talk portion of the Talk/End_talk call flow presented in the preceding figures, beginning with a NOTIFY message 828 being sent from the VUA-A 714 to the presence server 106. Once the connection in the conference server 108 is bridged, as signaled by a 200 OK message 830 from the presence server 106, the VUA-A 714 sends an Ack message 832 to the mobile application A 724 that may subsequently trigger an audible signal to the end user.

At this point of the process, the RTP connection between the VUA-A 724 and the VUA-B 726 is ready and active, as illustrated in 834. In such an embodiment, the user associated with the terminal 724 may start communicating with the user at the terminal 726. In an embodiment in which both terminals support RTP communication, the RTP flow may be supported between the two mobile terminals. Alternatively, the VUA-A 724 and the VUA-B 726 may convert RTP flow into codec samples for transmission to the terminals 724 and 726 and codec samples to RTP payload in an opposite direction.

When the user associated with the terminal 724 decides to terminate the communication with the user associated with the terminal 726, by releasing the “talk” button, for instance, the mobile application A 724 is triggered and sends an End_Talk_to message 836 to the VUA-A 714. The VUA-A 714 may then initiate the end_talk portion of the Talk/End_talk call flows described in the preceding Figures. Only the first message of the disconnection process, a NOTIFY message 838, is illustrated in FIG. 8. Upon the completion of the disconnection process, the RTP sessions go inactive, and both the VUA-A 714 and the VUA-B 716 maintain their RTP connections to the conference server 108, as illustrated in 840 and 842.

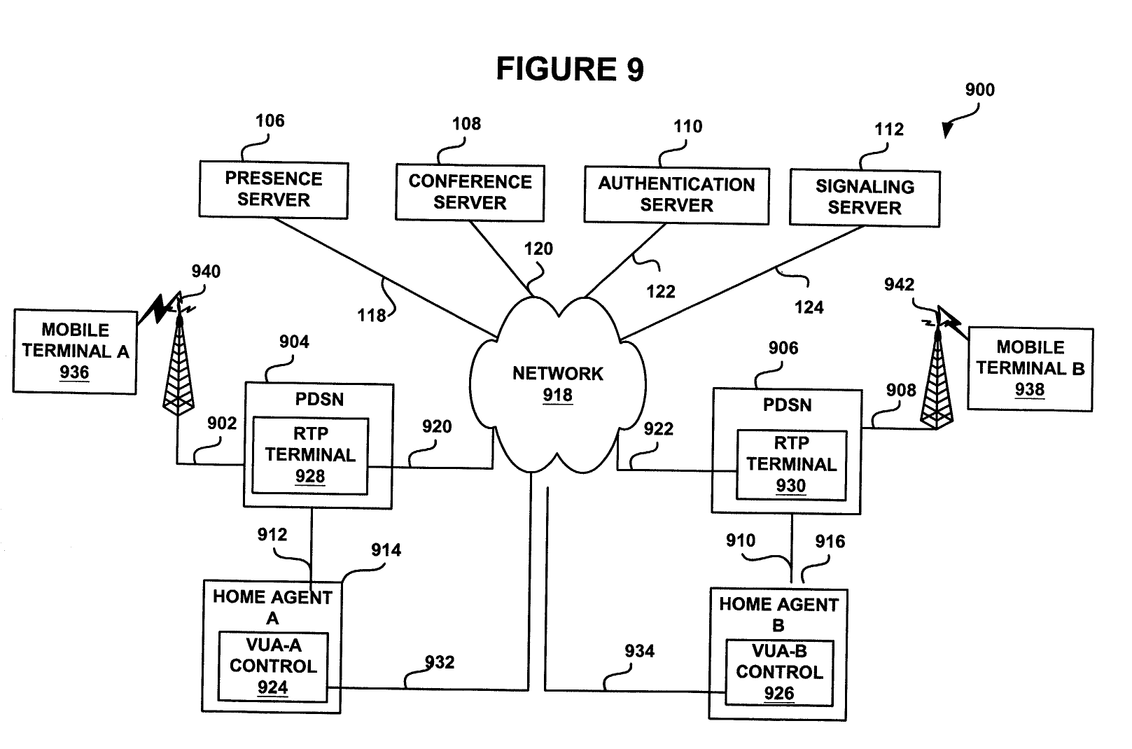

FIG. 9 is a block diagram illustrating an exemplary network architecture 900 of a 3G network that may be employed for instant voice messaging according to one exemplary embodiment in which mobile terminals do not support SIP user agents. In FIG. 9, PPP connections 902 and 908 from the mobile terminals 936 and 938 terminate at packet data serving nodes (PDSN) 904 and 906. In 3G networks, mobile IP may be used to provide user terminal mobility while maintaining an always on IP connection to a network 918 such as an IP network. It should be understood that data services and cellular services are not necessarily exclusive and may be simultaneously active. In the embodiment illustrated in FIG. 9, the mobile terminals'IP addresses are respectively hosted at their home agents (“HA”) 914 and 910, and mobile IP tunnels 912 and 910 are established between the HAs 914, 916 and the PDSNs 904 and 906.

In the embodiment illustrated in FIG. 9, a VUA is decomposed into a control element and an RTP media element. The control elements 924 and 926 are implemented as applications in the mobile terminal's HAs 914 and 916, and the RTP media elements 928 and 930 are implemented in the PDSNs 904 and 906. In such an embodiment, the RTP termination uses an IP address and port on the PDSN associated with the mobile terminal's PPP session. As described in reference to FIG. 7 related to the 2G case, the mobile terminals 936 and 938 host mobile applications. In this case, however, the client applications interface to the VUA control elements at the HAs, and to the VUA RTP media element at the other end of the PPP connection in the PDSN. In such an embodiment, the PDSNs 904 and 906 communicate RTP data to and from network 918 via connections 920 and 922, and tunnel IP data to the HAs 914 and 916 via connection 910 and 912.

In such an embodiment, for the terminal-to-network direction, raw codec samples may be transported in IP packets to the VUA RTP media elements 928 and 930 in the PDSNs 904 and 906. The media elements may subsequently create RTP packets, inserting the raw codec samples into the RTP payloads, and, then, may forward them to the conference server 108 over the already established RTP sessions. That is, the RTP stream is terminated in the PDSNs 904 and 906, which host the VUA RTP media elements 928 and 930. For the network-to-terminal direction, the steps are reversed. Again, it is assumed that the IP packets containing raw codec data include sufficient sequencing information to allow the mobile terminal application to play them out in a proper order. Further, connections 932 and 934 between the HA-hosted VUA control elements 924 and 926 and the network 918 support SIP and IP flows. Similarly, connections 920 and 922 between the PDSN-hosted RTP media elements 928 and 930 and the network 918 support RTP communications. However, it should be understood that FIG. 9 illustrates only an exemplary embodiment of the network architecture, and fewer, more, different or equivalent network elements could also be used.

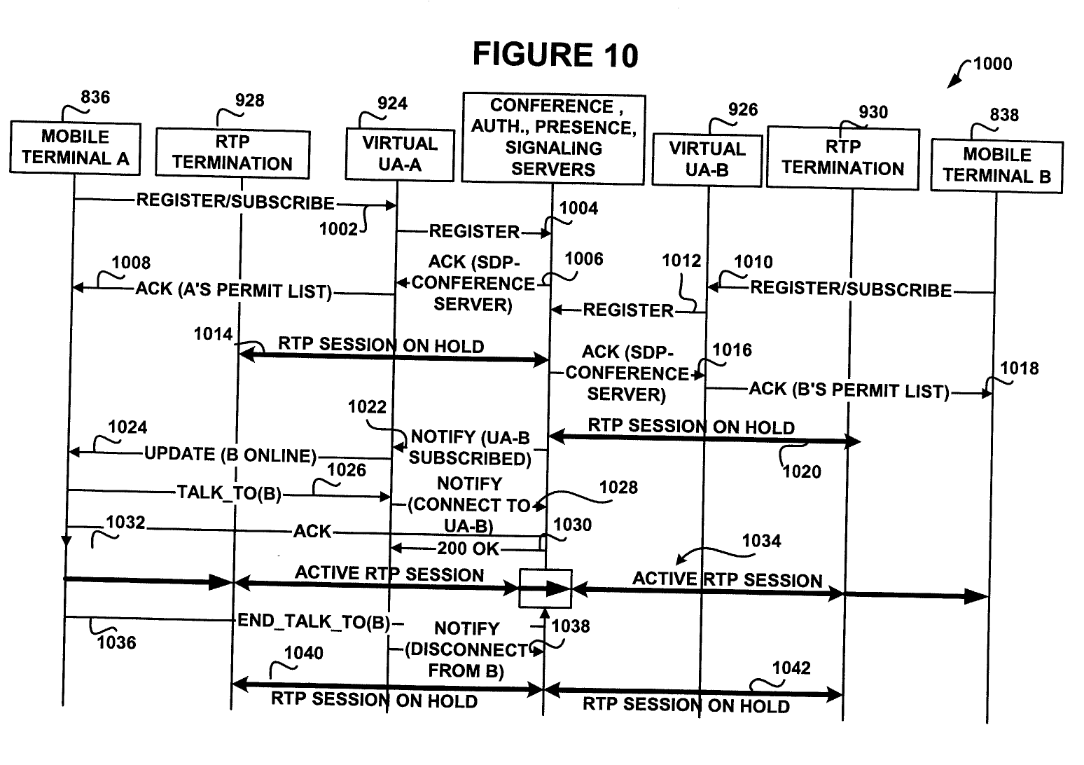

FIG. 10 illustrates a message flow 1000 for instant voice messaging in 3G network architecture illustrated in FIG. 9. Initially, the mobile application 936 registers and subscribes. The processes of registration and subscription are similar to those already described in reference to FIG. 8 depicting the message flow in 2G network, except for the termination of the RTP session. The messages associated with the registration and subscription for the mobile application A 936 are: a register/subscribe message 1002, a REGISTER message 1004, an ACK message 1006 and an ACK message 1008. Similarly, the messages associated with the process of subscribing and registration are: a register/subscribe message 1010, a REGISTER message 1012, an ACK message 1016 and an ACK message 1018. Upon the completion of the registration and subscription two RTP sessions 1014 and 1020 are created between the RTP terminations 928, 930 and the conference server 108.

Further, when the user associated with the terminal 216 completes the registration/subscription process, the presence server 106 sends a NOTIFY message 1022 to the VUA-A 924 that translates the info in the received message into a protocol employed between the VUA-A 924 and the terminal 936 for instant voice messaging communications. Subsequently, the VUA-A 924 sends to the terminal 936 an UPDATE message 1024 including information that the user associated with the terminal 938 is online.

When the user at the terminal 936 initiates communication with the user at the terminal 938, the mobile application at the terminal 936 generates and sends to the VUA-A 924 a TALK_TO(B) message 1026. When the VUA-A 924 receives the message 1026, the process of bridging the sessions is initiated. The message flow for bridging the connections has been described in reference to preceding figures, therefore, the message flow 1000 only illustrates the first and the last messages being sent between the VUA-A 924 and the conference server 108. Specifically, these messages are a NOTIFY message 1028 and a 200 OK message 1030. Subsequently, the VUA-A 924 sends an ACK message 1032 to the terminal 936, and the end-to-end media connection is available, as shown in 1034. As mentioned in reference to the network architecture illustrated in FIG. 9, the users may end the RTP connections at their respective PDSNs.

Further, similarly to the preceding figures, the user associated with the terminal 936 may end the connection to the terminating user. When the mobile application A 936 detects an input from the user indicating a termination of connection request, the mobile application A 936 generates and sends to the VUA-A 924 an END_TALK_TO(B) message 1036 that is then translated and sent to the presence server 106, as illustrated in a NOTIFY message 1038. The NOTIFY message 1038 initiates disconnection of the RTP bridge, and will not be described in reference to FIG. 10. The messages involved in disconnection of the RTP bridge has been described in reference to the preceding figures. Upon the end of the process, the RTP sessions 1040 and 1042 are back on hold.

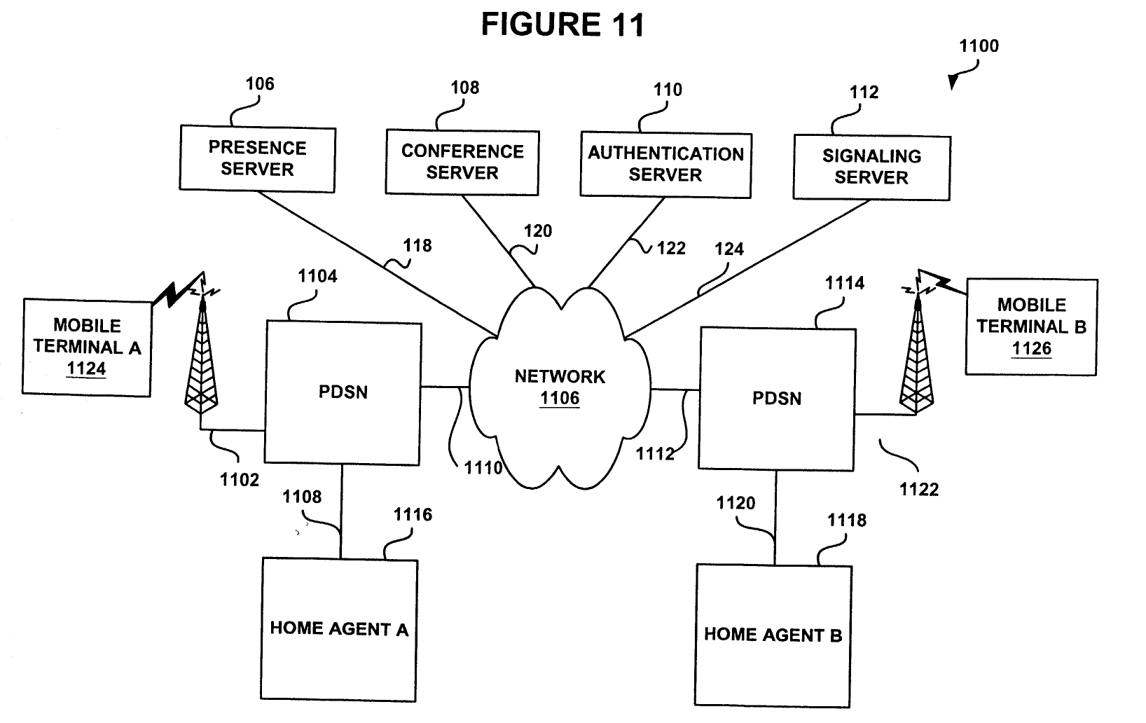

FIG. 11 is a block diagram illustrating a 3G network architecture 1100 for instant voice messaging according to another exemplary embodiment, in which mobile terminals are SIP-capable. FIG. 11 illustrates two mobile terminals 1124 and 1126 (SIP-capable) having PPP connections 1102 and 1122 terminated at PDSNs 1104 and 1114. Similarly, to the preceding network architectures, the PDSNs 1104 and 1114 communicate with respective home agents 1116 and 1118 via mobile IP connections 1108 and 1120. Further, as illustrated in FIG. 11, the PDSNs 1104 and 1114 are connected to a network 1106, such as an IP network, via communication links 1110 and 1112. Further, similarly to the preceding figures, the network architecture 1100 includes the conference server 106, the authentication server 110, the presence server 106 and the signaling server 112.

The difference between FIG. 11 and the network architecture illustrated in FIG. 9 is that there is no VUA, but rather the mobile terminals 1124 and 1126 host their own SIP user agents. Therefore, there is no need for any additional protocols or transport elements. In the embodiment illustrated in FIG. 11, SIP and RTP flows terminate directly at the mobile terminals.

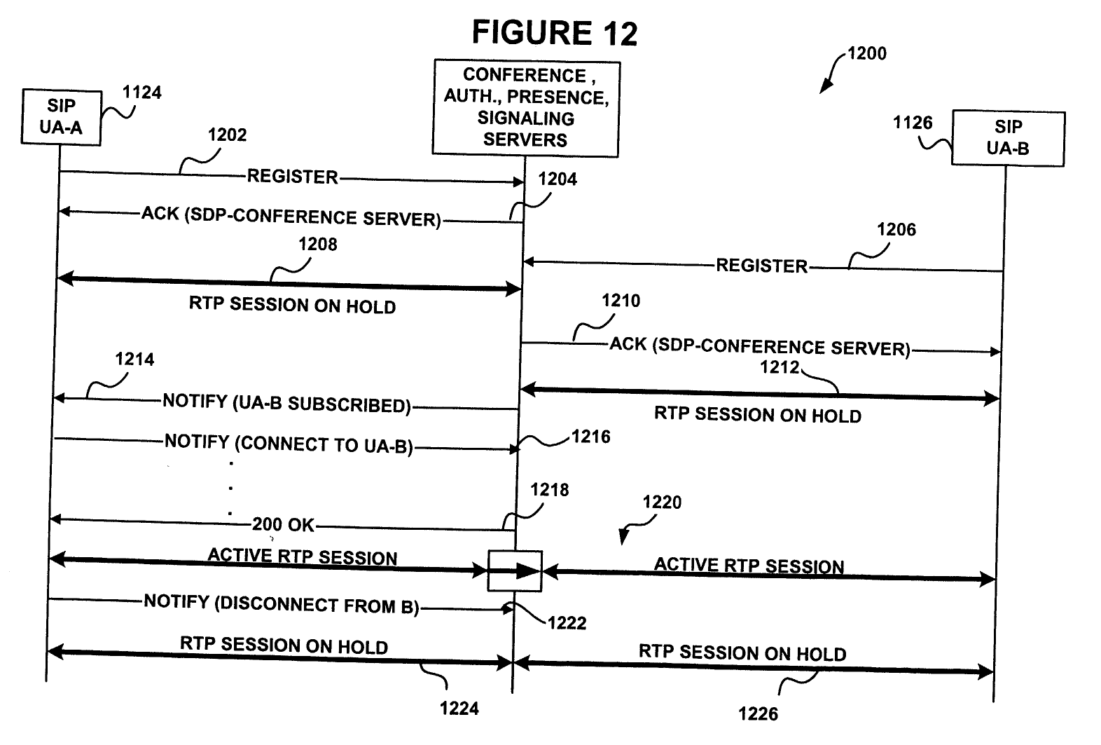

FIG. 12 is a message flow 1200 for instant voice messaging in the network architecture 1100 illustrated in FIG. 11. It should be understood that only abbreviated message flows are shown in FIG. 12, and the SIP user agent is hosted on the communicating mobile terminals. Initially, a SIP UA-A located at the mobile terminal 1124 registers and subscribes for the instant voice messaging service. In one embodiment, a mobile terminal may be configured to automatically initiate registration and subscription processes upon establishing a mobile IP session to the network. Alternatively, the registration and subscription may be executed upon receiving explicit instructions from a user. In either embodiment, the SIP UA-A 1124 sends a REGISTER message 1202 to the presence server 106, and culminates with an ACK message 1204 including the conference server's SDP, and establishment of the RTP session 1208 between the SIP user terminal 1124 and the conference server 108. At this point of the process, the UA-A 1124 is online and ready for instant voice messaging, according to an exemplary embodiment.

Similarly, the SIP UA-B 1128 registers and subscribes to instant voice messaging services. As illustrated in FIG. 12, the UA-B 1128 sends a REGISTER message 1206 to the presence server 106, and the process culminates with an ACK message 1210 including the conference server's SDP. Upon the end of subscription and registration, an RTP session 1212 is established between the conference server 108 and the user terminal 1128.

Subsequently, the UA-A 1124 receives a NOTIFY message 1214 including a notification that the user associated with the UA-B 1128 is online. Next, FIG. 12 illustrate an initiation of an instant voice message from the UA-A 1124 to the UA-B 1128. When a user depresses a “talk” button, for example, a process of bridging RTP sessions is initiated with the UA-A 1124 sending a NOTIFY message 1216 to the presence server 106 and, once the connections on the conference server 108 are bridged, the process culminates with the presence server 106 sending a 200 OK message 1218 to the UA-A 1124. When the UA-A 1128 receives the 200 OK message 1218, a user may be notified with an audible tone indicating the availability of connection 1220. The users may then start communicating.

Further, as illustrated in FIG. 12, when the user associated with the UA-A 1124 decides to end the communications by, for example, releasing the “talk” button, the UA-A 1124 may initiate a process of terminating the bridged connection. The process initiates with a NOTIFY message 1222 and terminates with the conference server 108 terminating the internal bridged connection, and leaving the two RTP sessions 1224 and 1226 to the terminals 1124 and 1126 on hold.

It should be understood that the programs, processes, methods and systems described herein are not related or limited to any particular type of computer or network system (hardware or software), unless indicated otherwise. Various types of general purpose or specialized computer systems supporting the IP networking may be used with or perform operations in accordance with the teachings described herein.

In view of the wide variety of embodiments to which the principles of the present invention can be applied, it should be understood that the illustrated embodiments are examples only, and should not be taken as limiting the scope of the present invention. For example, the steps of the flow diagrams may be taken in sequences other than those described, more or fewer steps may be used, and more or fewer elements may be used in the block diagrams. While various elements of the preferred embodiments have been described as being implemented in software, in other embodiments in hardware or firmware implementations may alternatively be used, and vice-versa. Further, it should be understood that different or equivalent messages could also be used. Additionally, those skilled in the art will understand that even if the abbreviated syntax is shown in some of the illustrated messages, the intended purpose of the messages may be easily recognized.

Further, it will be apparent to those of ordinary skill in the art that methods involved in the system for instant voice messaging may be embodied in a computer program product that includes one or more computer readable media. For example, a computer readable medium can include a readable memory device, such as a hard drive device, CD-ROM, a DVD-ROM, or a computer diskette, having computer readable program code segments stored thereon. The computer readable medium can also include a communications or transmission medium, such as, a bus or a communication link, either optical, wired or wireless having program code segments carried thereon as digital or analog data signals.

The claims should not be read as limited to the described order or elements unless stated to that effect. Therefore, all embodiments that come within the scope and spirit of the following claims and equivalents thereto are claimed as the invention.

What is claimed:

1. A method for providing instant services in an Internet Protocol network, the method comprising:
provisioning a first communication session between a first user terminal and a predetermined network device;
provisioning a second communication session between a second user terminal and the predetermined network device;
receiving an activation request to establish an active communication session between the first user terminal and the second user terminal;
bridging the first communication session to the second communication session on the predetermined network device.

2. A computer readable medium having stored therein instructions to execute the method of claim 1.

3. The method of claim 1, wherein the first communication session comprises a first real-time transport protocol session, and the second communication session comprises a second real-time transport protocol session.

4. The method of claim 1, prior to provisioning the first communication session, further comprising:
receiving a first registration request from a user associated with the first user terminal;
authenticating the first user in accordance with a first user account for the user associated with the first user terminal;
receiving a first subscription request from the user associated with the first user account, wherein the first subscription request comprises a request to subscribe to a first service.

5. The method of claim 4, wherein the first service comprises a multimedia service.

6. The method of claim 5, wherein the multimedia service comprises an instant voice messaging service.

7. The method of claim 4, further comprising:
receiving a first registration request from a user associated with the second user terminal;
authenticating the user in accordance with a first user account for the user associated with the second user terminal;
receiving a first subscription request from the user associated with the second user terminal, wherein the first subscription request comprises a request to subscribe to the first service using a first subscriber identification.

8. The method of claim 7, further comprising:
receiving a second subscription request from the user associated with the second user terminal, wherein the second subscription request comprises a request to subscribe to the first service using a second subscriber identification;
provisioning a third communication session between the second user terminal and the predetermined network device.

9. The method of claim 1, further comprising:
providing a first list of subscribers to the first user terminal, the first list of subscribers including subscriber identifications associated with active subscribers authorized to communicate with the user associated with the first user terminal; and
providing a second list of subscribers to the second user terminal, the second list of subscribers including subscriber identifications associated with active subscribers authorized to communicate with the user associated with the second user terminal.

10. The method of claim 1, wherein the first user terminal comprises a signaling agent, and the step of receiving the request to establish an active communication session between the first user terminal and the second user terminal comprises:
receiving a user input to establish the active communication session to the second user terminal;
sending the request to establish the active communication session between the first user terminal and the second user terminal from the signaling agent to the predetermined network device.

11. The method of claim 10, wherein the signaling agent comprises a Session Initiation Protocol (SIP) agent.

12. The method of claim 1, wherein the first user terminal is associated with a virtual signaling agent, and the step of receiving the request to establish an active communication session between the first user terminal and the second user terminal comprises:
receiving on the first user terminal a user input to establish the active communication session to the second user terminal;
sending to the virtual signaling agent a request to establish the active communication session;
sending from the virtual signaling agent to the predetermined network device the request to establish the active communication session between the first user terminal and the second user terminal.

13. The method of claim 1, further comprising:
receiving a request to terminate the active communication session between the first user terminal and the second user terminal; and
un-bridging the first communication session from the second communication session on the predetermined network device.

14. The method of claim 1, wherein the step of provisioning the first communication session and the second communication session comprises setting up the first and second communication sessions between the first and second user terminals and the predetermined network device prior to receiving the receiving the activation request.

15. The method of claim 1, wherein the first user terminal is associated with a first predetermined device and the second user terminal is associated with a second predetermined device, and wherein the first communication session is provisioned between the first user terminal and the first predetermined device, and the second communication session is provisioned between the second user terminal and the second predetermined device, and the step of bridging the first communication session to the second communication session comprises bridging the sessions via the first predetermined device and the second predetermined device.

16. A method for providing instant services in an Internet Protocol network, the method comprising:
receiving on a presence server from a first user terminal a request to subscribe to a multimedia service;
sending from the presence server to a conference server a request to provision a first communication session between the first user terminal and the conference server;
provisioning the first communication session between the first user terminal and the conference server responsive to receiving the request;
providing online status information associated with a user associated with the first user terminal to at least one user authorized to receive the online status information;
provisioning a second communication session between the conference server and a second user terminal;
providing online status information associated with a user associated with the second user terminal to the user associated with the first user terminal;
receiving on the conference server an activation request to establish an active session between the first user terminal and the second user terminal;
bridging the first communication session to the second communication session on the conference server.

17. The method of claim 16 wherein the step of bridging the first communication session to the second communication session comprises enabling half-duplex communications from the first user terminal to the second user terminal.

18. The method of claim 16, further comprising authenticating the user associated with the first user terminal before sending the request to provision the first communication session between the first user terminal and the conference server.

19. The method of claim 16, wherein the activation request comprises a request from the user associated with the first user terminal, and the method further comprises determining if the user associated with the second user terminal is available prior to bridging the first communication session to the second communications session.

20. The method of claim 16, further comprising:
provisioning a third communication session between the conference server and a third user terminal;
receiving on the conference server an activation request to establish active sessions between the first user terminal, the second user terminal and the third user terminal; and
bridging the first communications session to the second communication session and the third communication session.

21. The method of claim 16, wherein the first communication session and the second communication session comprise real-time transport protocol sessions.

22. The method of claim 16, wherein the request to subscribe comprises a request to subscribe to a predetermined service.

23. The method of claim 22, wherein the predetermined service comprises an instant voice messaging service.

24. A system for providing instant services in an Internet Protocol network, the system comprising:
a conference server configured to provision at least one communication session to a first user terminal and a second user terminal, the conference server being further configured to bridge the at least one communication session between the first user terminal and the second terminal upon receiving a communication session activation request, and further to un-bridge the sessions upon receiving a deactivation request;
an authentication server configured to authenticate user requests;
a presence server configured to store user profiles, to track user status information associated with user terminals, and to provide the user status information to authorized user, the presence server being further configured to receive a communication session activation request and, responsively, to determine an availability of at least one destination terminal specified in the request, wherein, if the at least one destination terminal is available the presence server is configure to forward the request to the conference server.

25. The system of claim 24, further comprising a second conference server, and the presence server is further configured to maintain a state and availability of each conference server.

26. The system of claim 25, wherein the presence server is further configured to manage the assignment of conference servers to user terminals upon receiving registration and subscription requests from the users associated with the user terminals.

27. The system of claim 24, further comprising:
at least one signaling user agent configured to provide control protocol and signaling interface between the user terminal, the conference server and the presence server.

28. The system of claim 27, wherein the at least one signaling user agent comprises at least one Session Initiation Protocol user agent.

29. The system of claim 27, wherein the first user terminal comprises a first signaling user agent, and the second user terminal comprises a second signaling user agent.

30. The system of claim 28, wherein the at least one signaling user agent comprises a virtual user agent.

31. The system of claim 30, wherein the virtual user agent comprises a user agent located remotely from the user terminal.

32. The system of claim 30, wherein the virtual user agent is remotely controlled by the user terminal, and comprises a remote control protocol, a remote interface, and a remote media transport function.

33. The system for providing real-time data transmission in an Internet Protocol network, the system comprising:
a plurality of conference servers comprising a first conference server and a second conference server, the first conference server configured to provision at least one communication session to a first user associated with a first user terminal, and the second conference server configured to provision at least one communication session to a second user associated with a second user terminal, the first conference server and the second conference server being further configured to bridge the at least one communication session between the first user terminal and the second user terminal upon receiving a communication session activation request, and further being configured to un-bridge the sessions upon receiving a communication session deactivation request;
a presence server configured to assign the first user to the first conference server and the second user to the second conference server upon receiving registration requests from the first user and the second user, the presence server being further configured to receive from the first user a communication session activation request to establish a communication session with the second user and, responsively, determine an association of the second user with the second conference server and an association of the first user with the first conference server, and the presence server being further configured to send a first request to the first conference server and a second request the second conference server, wherein the first request comprises a request to bridge the at least one communication session provisioned for the first user to the second conference server, and the second request comprises a request to bridge the at least one communication session provisioned for the second user to the first conference server.

34. The system of claim 33, wherein the presence server is further configured to determine an availability of the second user terminal upon receiving the communication session activation request from the first user, and wherein the presence server is configured to send the first request to the first conference server and the second request to the second conference server if the second user is available.

35. The system of claim 33, wherein the at least one communication session provisioned for the first user terminal and the at least one communication session provisioned for the second user terminal comprise a real-time transport protocol sessions.
